(19) United States
(12) Patent Application Publication
(10) Pub. No.: US 2025/0216694 A1
(43) Pub. Date: Jul. 3, 2025

(54) DISPLAY APPARATUS

(71) Applicant: SAMSUNG ELECTRONICS CO., LTD., Suwon-si (KR)

(72) Inventors: Taesoon PARK, Suwon-si (KR); Kwansik MIN, Suwon-si (KR)

(73) Assignee: SAMSUNG ELECTRONICS CO., LTD., Suwon-si (KR)

(21) Appl. No.: 19/085,408

(22) Filed: Mar. 20, 2025

Related U.S. Application Data
(63) Continuation of application No. PCT/KR2023/015967, filed on Oct. 17, 2023.

(30) Foreign Application Priority Data
Dec. 15, 2022 (KR) 10-2022-0176359

(51) Int. Cl. G02B 30/31; G02F 1/31

(52) U.S. Cl. CPC G02B 30/31; G02F 1/31

(57) ABSTRACT

A display apparatus includes: a light source module configured to irradiate light; a first substrate disposed in front of the light source module and configured to transmit the light; a second substrate facing the first substrate and configured to transmit the light irradiated by the light source module; and a switching layer between the first substrate and the second substrate and including: a first surface having a first electrode; a second surface having a second electrode facing the first surface; and a switching cell, arranged between the first surface and the second surface and including movable charged particles having of a light-blocking material, configured to transmit or block the light based on an electric potential difference applied to the first electrode and the second electrode. The switching cell has a shape with a decreasing width in an extending direction of the first surface from the second surface toward the first surface.

### CROSS-REFERENCE TO RELATED APPLICATIONS

This application is a continuation application of International Application No. PCT/KR2023/015967, filed on Oct. 17, 2023, in the Korean Intellectual Property Receiving Office, which claims priority to Korean Patent Application No. 10-2022-0176359, filed on Dec. 15, 2022, in the Korean Intellectual Property Office, the disclosures of which are incorporated by reference herein in their entireties.

### BACKGROUND

### 1. Field

The disclosure relates to a display apparatus, and more particularly, to a display apparatus for providing a two-dimensional (2D) image or a three-dimensional (3D) image.

### 2. Description of Related Art

A three-dimensional (3D) image display apparatus may provide a three-dimensional (3D) image for the user by modulating external light or light irradiated from a built-in light source. To provide 3D images, a holography method or a stereoscopy method may be executed.

Although the holography method is an ideal 3D image display method, it requires a coherent light source and includes a difficulty in recording and representing a large object located at a far distance.

The stereoscopy method includes a 3D effect by separating two two-dimensional (2D) images having binocular disparity and showing each one for either of the human eyes, thereby implementing a 3D image in a relatively simple manner because it uses the two flat images.

The stereoscopy method includes a spectacle type that uses an aid for either eye to view a separate image and an auto-stereoscopic type that forms a viewing area by dividing an image directly on a display. The auto-stereoscopic type is classified into a parallax barrier type using a parallax barrier, a lenticular lens type, etc. Among them, the parallax barrier type uses a principle that creates binocular parallax by separating left and right images through slits arranged to transmit or block light.

### SUMMARY

According to an aspect of the disclosure, a display apparatus includes: a light source module configured to irradiate light; a first substrate disposed in front of the light source module in a forward direction and configured to transmit the light irradiated by the light source module; a second substrate facing the first substrate and between the first substrate and the light source module and configured to transmit the light irradiated by the light source module; and a switching layer between the first substrate and the second substrate and including: a first surface having a first electrode arranged thereon; a second surface having a second electrode arranged thereon and facing the first surface; and a switching cell, arranged between the first surface and the second surface and including movable charged particles having of a light-blocking material, configured to transmit or block the light based on an electric potential difference applied to the first electrode and the second electrode. The switching cell has a shape with a decreasing width in an extending direction of the first surface from the second surface toward the first surface.

The switching cell may include an inclined surface between the first electrode and the second electrode with respect to a direction perpendicular to each of the first surface and the second surface. The inclined surface may be on an inner surface of the switching cell.

A distance between a first end of the inclined surface adjacent to the first surface and the first electrode in the extending direction of the first surface may be less than a distance between a second end of the inclined surface adjacent to the second surface and the first electrode in the extending direction of the first surface.

The inclined surface may include a plurality of inclined surfaces facing each other. The plurality of inclined surfaces may extend to be closer to each other toward the first electrode.

The inclined surface may extend from the second surface to the first surface.

The switching cell may extend in a direction parallel to the extending direction of the first surface and the second surface. The inclined surface may extend in the direction parallel to the extending direction of the first surface and the second surface.

A first end of the switching cell on the first surface may have a width corresponding to a width of the first electrode. A second end of the switching cell on the second surface may have a width corresponding to a width of the second electrode.

The width of the first end of the switching cell may be less than the width of the second end of the switching cell.

The first surface may be on one side of the switching layer facing the first substrate. The first electrode may be connected to the first substrate. The second surface may be on another side of the switching layer facing the second substrate. The second electrode may be connected to the second substrate.

The display apparatus may further include one or more processors. A power supply may be connected to the first electrode and the second electrode and configured to apply an electric field between the first electrode and the second electrode. The one or more processors may be configured to control the power supply to apply the electric field between the first electrode and the second electrode for applying electric force to charged particles in the switching cell to be directed to the first electrode, based on an electric signal for the switching cell to perform a transmitting mode for transmitting the light.

The one or more processors may be further configured to control the power supply not to apply the electric field between the first electrode and the second electrode, based on an electric signal for the switching cell to perform a blocking mode for blocking the light.

The one or more processors may be further configured to: control the power supply to perform the transmitting mode based on a first content signal for displaying a first type of content image, the first content signal being based on a first user input; and control the power supply to perform the blocking mode based on a second content signal for displaying a second type of content image, the second content signal being based on a second user input different than the first user input, and the second type of content image being different from the first type of content image.

The switching cell may include a plurality of switching cells spaced apart from each other. The switching layer may further include a transmission portion between the plurality of switching cells and configured to transmit the light. A boundary between the transmission portion and each of the plurality of switching cells may extend obliquely in a direction perpendicular to each of the first surface and the second surface.

Each of the plurality of switching cells may include a dispersion medium in each of the plurality of switching cells and configured to transmit the light. The transmission portion may be a material having a refraction index corresponding to a refraction index of the dispersion medium.

The plurality of switching cells may be arranged at equal intervals.

According to one or more embodiments, provided is a display apparatus having an enhanced structure to selectively display a two-dimensional (2D) image or a three-dimensional (3D) image.

According to one or more embodiments, provided is a display apparatus having an enhanced structure to enhance brightness of a display panel in displaying a 2D image.

According to one or more embodiments, a display apparatus may selectively display a two-dimensional (2D) image or a three-dimensional (3D) image through a display panel by including a switching cell that accommodates charged particles moved according to whether there is an electric potential difference and formed of a light-blocking material.

According to one or more embodiments, a display apparatus may enhance brightness of a display panel in displaying a 2D image by including a switching cell having a shape with decreasing width toward one electrode.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a perspective view of a display apparatus, according to one or more embodiments of the disclosure;

FIG. 2 is an exploded perspective view of a display apparatus, according to one or more embodiments of the disclosure;

FIG. 3 is a cross-sectional view of some components of a display apparatus, according to one or more embodiments of the disclosure;

FIG. 4 is a cross-sectional view of some components of a display apparatus, according to one or more embodiments of the disclosure;

FIG. 5 is a cross-sectional view of some components of a display apparatus, according to one or more embodiments of the disclosure;

FIG. 6 is a block diagram illustrating a configuration of a display apparatus, according to one or more embodiments of the disclosure;

FIG. 7 is a perspective view of a parallax barrier of a display apparatus, according to one or more embodiments of the disclosure;

FIG. 8 is a cross-sectional view of a parallax barrier of a display apparatus, according to one or more embodiments of the disclosure;

FIG. 9 is an enlarged view of some components of a parallax barrier of a display apparatus, according to one or more embodiments of the disclosure;

FIG. 10 is a cross-sectional view of a parallax barrier of a display apparatus in a transmitting mode, according to one or more embodiments of the disclosure;

FIG. 11 is a cross-sectional view of a parallax barrier of a display apparatus in a blocking mode, according to one or more embodiments of the disclosure;

FIG. 12 is a flowchart illustrating a method of controlling a display apparatus, according to one or more embodiments of the disclosure;

FIG. 13 is a flowchart illustrating a method of controlling a display apparatus, according to one or more embodiments of the disclosure;

FIG. 14 is a flowchart illustrating a method of controlling a display apparatus, according to one or more embodiments of the disclosure;

FIG. 15 is a cross-sectional view of a parallax barrier of a display apparatus, according to one or more embodiments of the disclosure;

FIG. 16 is a cross-sectional view of a parallax barrier of a display apparatus, according to one or more embodiments of the disclosure; and

FIG. 17 is a cross-sectional view of a parallax barrier of a display apparatus, according to one or more embodiments of the disclosure.

### DETAILED DESCRIPTION

Embodiments and features as described and illustrated in the disclosure are merely examples, and there may be various modifications replacing the embodiments and drawings at the time of filing this application.

Throughout the drawings, like reference numerals refer to like parts or components.

The terminology used herein is for the purpose of describing particular embodiments only and is not intended to limit the disclosure. It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first component discussed below could be termed a second component and vice versa, without departing from the teachings of the disclosure. Descriptions shall be understood as to include any and all combinations of one or more of the associated listed items when the items are described by using the conjunctive term “˜ and/or ˜,” or the like.

The terms “up-down direction or vertical direction”, “lower side” and “front-back direction” as herein used are defined with respect to the drawings, but the terms may not restrict the shape and position of the respective components. For example, the term “up-down direction or vertical direction” may refer to direction Z with respect to each drawing. The term “front-back direction” may refer to direction X with respect to the drawings. The term “left-right direction” may refer to direction Y with respect to the drawings. The term “horizontal direction” may refer to direction X, direction Y or all directions on plane X-Y with respect to the drawings.

The term ‘unit, module, member, or block’ may refer to what is implemented in software or hardware, and a plurality of units, modules, members, or blocks may be integrated in one component or the unit, module, member, or block may include a plurality of components, depending on the embodiment of the disclosure.

It will be further understood that the term “connect” or its derivatives refer both to direct and indirect connection, and the indirect connection includes a connection over a wireless communication network.

Reference will now be made in detail to embodiments of the disclosure, which are illustrated in the accompanying drawings.

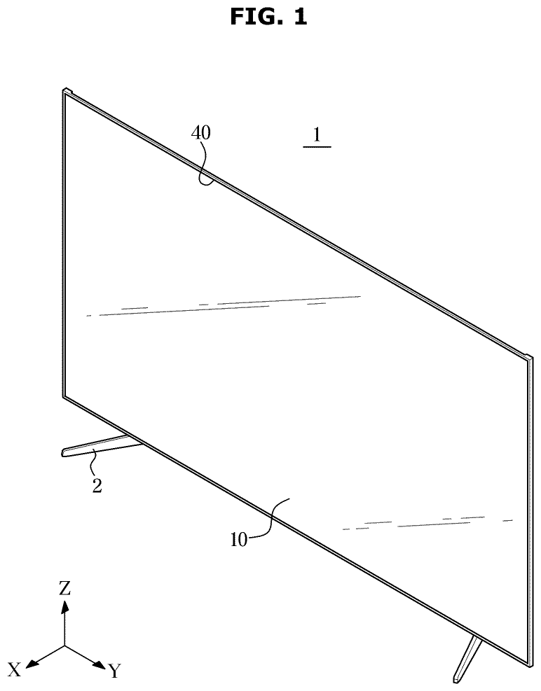

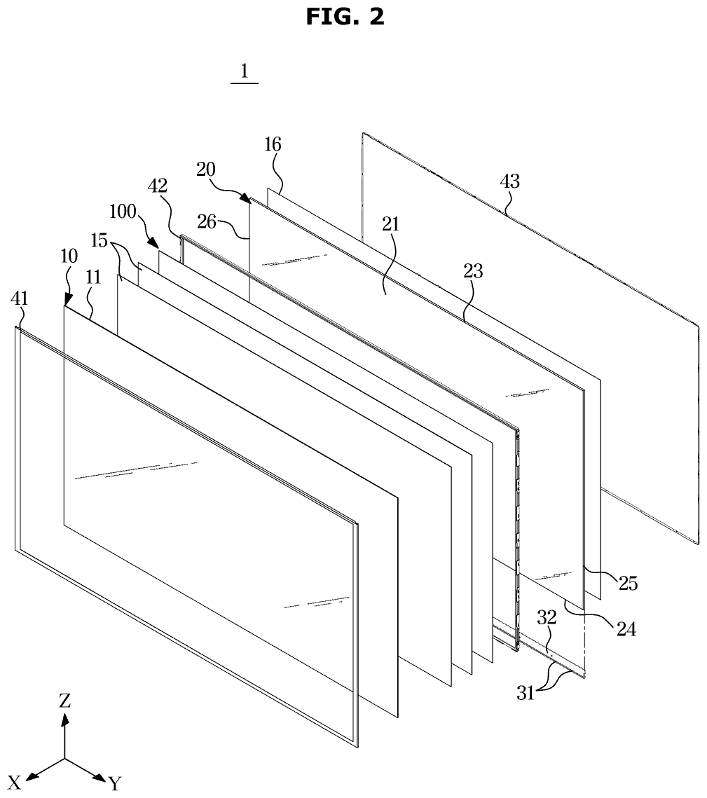

FIG. 1 is a perspective view of a display apparatus, according to one or more embodiments of the disclosure. FIG. 2 is an exploded perspective view of a display apparatus, according to one or more embodiments of the disclosure.

Referring to FIGS. 1 and 2, a display apparatus 1 is a device that is able to process an image signal received from the outside and visually present the processed image. Although the display apparatus 1 is shown as a television (TV) in FIGS. 1 and 2, it is not limited thereto. For example, the display apparatus 1 may be implemented in various forms such as a monitor that is a sort of computer output device, a portable multimedia device, a portable communication device, and any device capable of visually presenting images, without being limited thereto.

The display apparatus 1 may be a large format display (LFD) installed outdoors such as on a rooftop of a building or at a bus stop. The display apparatus 1 is not, however, exclusively installed outdoors, but may be installed at any place, even indoors with a lot of foot traffic, e.g., at subway stations, shopping malls, theaters, offices, stores, etc.

Although the display apparatus 1 is illustrated as a flat display apparatus with a flat screen in FIGS. 1 and 2, it is not limited thereto and the display apparatus according to the disclosure may be equally applied to a curved display apparatus or a bendable or flexible display apparatus that is variable between a flat state and a curved state. The configuration of the disclosure may also be applied to various standards of display apparatuses regardless of the screen size or ratio of the display apparatuses.

The display apparatus 1 may be installed in a standing manner on an indoor or outdoor floor or furniture, or may be installed on a wall or inside the wall in a wall-mounted manner. For example, the display apparatus 1 may include support legs 2 provided underneath the display apparatus 1 to be installed in the standing manner on the indoor or outdoor floor or furniture.

The display apparatus 1 may receive contents including video and audio signals from various content sources and output video and audio corresponding to the video and audio signals. For example, the display apparatus 1 may receive content data through a broadcast receiving antenna or a cable, receive content data from a content reproducing device, or receive content data from a content providing server of a content provider.

The display apparatus 1 may display an image corresponding to the video data, and output sound corresponding to the audio data. For example, the display apparatus 1 may reconstruct a plurality of image frames included in the video data and display the plurality of image frames successively. Furthermore, the display apparatus 1 may reconstruct an audio signal included in the audio data and successively output sounds based on the audio signal.

The display apparatus 1 may be configured to display a screen. Specifically, the display apparatus 1 may include a display panel 10 for displaying images on the front.

A plurality of pixels may be formed on the display panel 10, and a screen displayed on the display panel 10 may be formed by a combination of rays emitted from the plurality of pixels. For example, the rays emitted by the plurality of pixels may be combined like mosaics into a screen.

The plurality of pixels may emit light in various colors and brightness. Specifically, each of the plurality of pixels may include subpixels, and the subpixels may include a red subpixel to emit red light, a green subpixel to emit green light, and blue subpixel to emit blue light By combinations of the light emitted from each of the red subpixel, the green subpixel and the blue subpixel, each of the plurality of pixels may emit light of various brightness and colors.

The display panel 10 may be shaped almost like a rectangle. For example, the display panel 10 may have a form with vertical and horizontal lengths different from each other. That is, the display panel 10 may have long sides and short sides. The display panel 10 may be shaped like a rectangular plate. It is not, however, limited thereto, and the display panel 10 may have the form of a square plate with long and short sides being the same in length.

The display panel 10 may be formed in various sizes. A ratio of long side to short side or an aspect ratio of the display panel 10 may be any ratio unlike the general case such as 16:9 or 4:3.

For example, the display panel 10 may be configured as a non-emissive display type panel such as a liquid crystal display (LCD).

In a case that the display panel 10 is an LCD panel, the display panel 10 may include a thin-film transistor (TFT) substrate with thin-film transistors arranged thereon in the form of a matrix, a color-filter substrate coupled in parallel with the thin-film transistor substrate, and liquid crystal injected between the thin-film transistor substrate and the color-filter substrate and having optical properties that vary by changes in voltage or temperature.

The display apparatus 1 may include a light source module that irradiates light. As shown in FIGS. 1 and 2, the display apparatus 1 of the non-emissive type may include a backlight unit (BLU). The BLU may be arranged to emit light toward the display panel 10 from behind the display panel 10. In this case, the display panel 10 may block or pass the light emitted from the BLU.

The BLU may include a light source 31 for emitting light, and a light guide plate 20 for guiding the light emitted from the light source 31 to the liquid crystal panel 10. The light source 31 may include point light sources for emitting monochromatic light or white light. The light guide plate 20 may be arranged to convert the light irradiated from the light source 31 to surface light. Accordingly, the BLU may irradiate the surface light forward.

The light source 31 will now be assumed with reference to FIG. 2 to be an edge type BLU that irradiates light toward the edges of the light guide plate 20, but it is not limited thereto and the BLU of the display apparatus according to an aspect of the disclosure may be implemented as a direct type BLU with a light source that irradiates light forward.

The light source 31 may be mounted on a printed circuit board (PCB) 32. The light source 31 may be vertically mounted on the PCB 32. The PCB 32 may have a circuit pattern formed to transmit driving power and signals to the light source 31. For the light source 31, a light emitting diode (LED), a cold cathode fluorescent lamp (CCFL), an external electrode fluorescent lamp (EEFL), etc., may be used.

The light source 31 may be provided in the plural. The plurality of light sources 31 may be arranged in a line on the PCB 32. The plurality of light sources 31 may be mounted on the PCB 32 at regular or equal intervals.

The light guide plate 20 may be located behind the liquid crystal panel 10. The light guide plate 20 may convert light emitted from the light source 31 to surface light and guide the surface light to the liquid crystal panel 10. The light guide plate 20 may be formed of a poly methyl methacrylate acrylate (PMMA) material. Various patterns may be formed on the light guide plate 20 to change the path of light.

The light guide plate 20 may be formed in the shape of substantially a cuboid. Specifically, the light guide plate 20 may have a front side 21, a rear side 22 and thick sides 23, 24, 25 and 26. The thick sides 23, 24, 25 and 26 may include an upper thick side 23, a lower thick side 24, a left thick side 25 and a right thick side 26. Light enters the light guide plate 20 through at least one of the thick sides 23, 24, 25 and 26 of the light guide plate 20, and exits from the light guide plate through the front side 21 of the light guide plate 20. The light that exits through the front side 21 of the light guide plate 20 may be guided to the liquid crystal panel 10. The side on which the light is incident among the thick sides 23, 24, 25 and 26 of the light guide plate 20 may be referred to as an entrance side of the light guide plate 20, and the front side 21 of the light guide plate 20 may be referred to as an exit side of the light guide plate 20.

For example, the light source 31 may emit light toward the lower thick side 24 among the thick sides 23, 24, 25 and 26 of the light guide plate 20. For this, the light source 31 may be placed adjacent to the lower thick side 24 of the light guide plate 20. The PCB 32 may be arranged width ways to be parallel to the lower thick side 24 of the light guide plate 20. The plurality of light sources 31 may be arranged width ways to be parallel to the lower thick side 24.

The arrangement of the light sources 31 is not, however, limited thereto, and the light sources 31 may be arranged to be adjacent to at least one of the thick sides 23, 24, 25 and 26 of the light guide plate 20 so that light enters the light guide plate 20 through the at least one of the thick sides 23, 24, 25 and 26 of the light guide plate 20.

The BLU may include a reflection sheet 16 for preventing light loss by reflecting light, and various optical sheets 15 for enhancing optical characteristics.

The reflection sheet 16 may be placed on the rear side 22 of the light guide plate 20 to make the light emitted from the light source 31 enter the light guide plate 20 or make the light exiting from the light guide plate 20 re-enter the light guide plate 20.

The optical sheet 15 may include a quantum dot sheet to enhance color reproduction performance by changing the wavelength of light. Quantum dots, which are illuminant semiconductor crystals in a few nanometers, may be distributed inside the quantum dot sheet. The quantum dot may receive blue light to produce light of various wavelengths, i.e., any colors of visible light depending on the size. The optical sheet 15 may include a diffusion sheet for offsetting the effect from the pattern of the light guide plate 20. The optical sheet 15 may include a prism sheet for enhancing brightness by concentrating light.

The type of the display panel of the display apparatus according to an aspect of the disclosure is not, however, limited thereto, and the display panel 10 may be implemented as a self-luminous display type panel such as an organic LED (OLED) or a micro LED. In the self-luminous type display apparatus, the display panel may include a light source module that autonomously emits light.

On one side of the display panel 10, provided are a cable (not shown) for transmitting image data to the display panel 10 and a display driver integrated circuit (DDI) (not shown) for processing digital image data to output an analog image signal.

The display apparatus 1 may include a display case 40 for supporting the display panel 10. The display case 40 may support the front, sides and back of the display panel 10. The display case 40 may define the exterior of the display apparatus 1. Parts such as the display panel 10 for the display apparatus 1 to display images or perform many different functions may be accommodated in the display case 40.

Although the display case 40 is shown as being shaped like a flat plate in FIGS. 1 and 2, the shape of the display case is not limited thereto in the display apparatus according to an aspect of the disclosure. For example, the display case may be shaped like a curved plate to correspond to a shape of the display panel. Alternatively, the display case may be arranged to be switchable between a flat state and a curved state, and may be applied to a bendable or flexible display apparatus.

The display case 40 may include a top chassis 41 that supports the front and sides of the display panel 10. The top chassis 41 may be arranged on the front of the display apparatus 1 to be shaped like a rectangular frame.

The top chassis 41 may form a bezel placed toward the front of the display apparatus 1 to support the front of the display panel 10. However, in a case that the display apparatus 1 is a bezel-less type display apparatus without bezel or with very narrow bezel, the top chassis 41 may be arranged to support only the sides of the display panel 10. Furthermore, when a bottom chassis 43 supports the sides of the display panel 10, the display apparatus 1 may not include the top chassis 41.

The display apparatus 1 may include the bottom chassis 43 to support the back of the display panel 10. The bottom chassis 43 may cover the back of the display panel 10. The bottom chassis 43 may be coupled to the back of the top chassis 41. The bottom chassis 43 may support various parts of the display apparatus 1 such as the BLU (not shown), a printed circuit board assembly (PBA) (not shown) on which various electronic parts are mounted, etc.

The bottom chassis 43 may be formed to have the shape of a substantially flat plate, but is not limited thereto. The bottom chassis 43 may be formed to have a material having high thermal conductivity to radiate heat produced from the light source 31 to the outside. For example, the bottom chassis 43 may be formed to have a metal substance such as aluminum, SUS, etc., or a plastic substance such as ABS.

The display case 40 may include a middle mold 42 arranged between the top chassis 41 and the bottom chassis 43, and the middle mold 42 may support the BLU. The middle mold 42 may support a parallax barrier 100, which will be described later.

The display apparatus 1 may include a rear cover (not shown) that defines a rear exterior of the display apparatus 1. The rear cover may be placed behind the bottom chassis 43 to cover the bottom chassis 43 and various parts mounted on the back of the bottom chassis 43.

The rear cover may be coupled to the aforementioned support legs 2.

In the meantime, unlike what is shown in FIGS. 1 and 2, the display case of the display apparatus 1 according to an aspect of the disclosure may not include some of the top chassis, the middle mold and he bottom chassis. For example, the display panel of the display apparatus according to an aspect of the disclosure may be a self-luminous display panel such as an OLED panel, in which case the BLU is not provided in the display apparatus and so, the middle mold may be provided either.

The configuration of the display apparatus 1 as described above in connection with FIGS. 1 and 2 is merely an example of a display apparatus according to the disclosure, without being limited thereto. The display apparatus according to the disclosure may be configured to include various components to perform a function that provides an image through a screen.

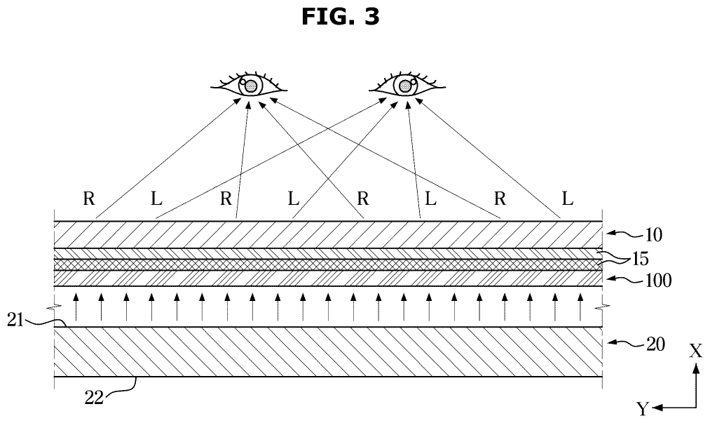

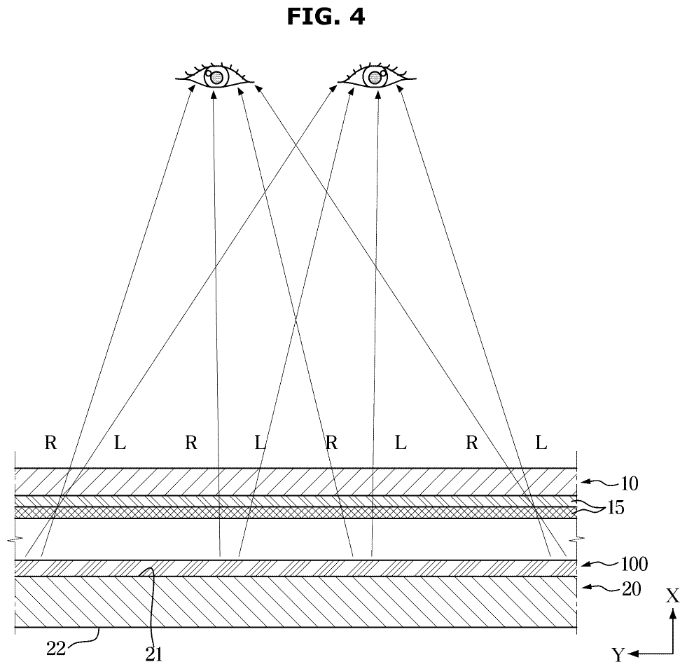

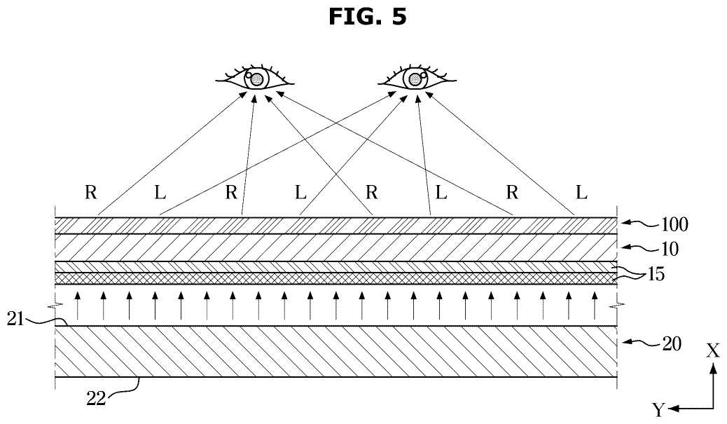

FIG. 3 is a cross-sectional view of some components of a display apparatus, according to one or more embodiments of the disclosure. FIG. 4 is a cross-sectional view of some components of a display apparatus, according to one or more embodiments of the disclosure. FIG. 5 is a cross-sectional view of some components of a display apparatus, according to one or more embodiments of the disclosure.

Referring to FIGS. 3 to 5, the display apparatus 1 may include a parallax barrier 100. The parallax barrier 100 may be arranged in front of or behind the display panel 10. The parallax barrier 100 may extend in parallel with the display panel 10.

As described above, the display panel 10 may display an image through a combination of rays emitted from the plurality of pixels. In this case, the plurality of pixels arranged in the display panel 10 may be divided into left-eye pixels L and right-eye pixels R, and the left-eye pixels L and the right-eye pixels R may be alternately arranged. To provide the user with a three-dimensional (3D) image, the left-eye pixels L may display an image for the left eye, and the right-eye pixels R may display an image for the right eye.

The parallax barrier 100 may be arranged to selectively transmit rays irradiated from the light source module of the display apparatus 1. The parallax barrier 100 may be arranged in front of the light source module and may selectively transmit rays irradiated forward from the light source module. To provide a 3D image for the user, the parallax barrier 100 may be arranged to separate paths of light such that the light that passes the left pixel L is to be recognized by the left eye of the user and the light that passes the right pixel R is to be recognized by the right eye of the user. Accordingly, the user may recognize the divided images for the left and right eyes, and the display apparatus 1 may give the user a 3D effect by using the binocular parallax.

Specifically, as shown in FIGS. 3 and 4, the parallax barrier 100 may be arranged behind the display panel 10. In this case, the light guide plate 20 that serves as a light source module may irradiate light toward the front of the display apparatus 1, and the parallax barrier 100 may selectively transmit the incident light from the light guide plate 20 to be irradiated to the display panel 10. A portion of the light transmitted through the parallax barrier 100 may be irradiated toward the left-eye pixels L of the display panel 10, and the other portion of the light transmitted through the parallax barrier 100 may be irradiated toward the right-eye pixels R of the display panel 10.

For example, as shown in FIG. 3, the parallax barrier 100 may be arranged to be adjacent to the rear side of the display panel 10. The parallax barrier 100 may be placed behind the optical sheet 15 as shown in FIG. 3, or placed between the display panel 10 and the optical sheet 15 unlike what is shown in FIG. 3. Alternatively, for example, as shown in FIG. 4, the parallax barrier 100 may be arranged to be adjacent to the front side 21 of the light guide plate 20.

Alternatively, as shown in FIG. 5, the parallax barrier 100 may be arranged in front of the display panel 10. The light irradiated from the light guide plate 20 may enter the display panel 10, and the light that passes the left-eye pixels L and the light that passes the right-eye pixels R of the display panel 10 may evenly exit to the front of the display panel 10. The parallax barrier 100 may selectively transmit the light that evenly exits forward from the display panel 10. The parallax barrier 100 may transmit only a portion of rays that exit from the left-eye pixel L of the display panel 10, which proceeds along the path toward the left eye of the user, and transmit only a portion of rays that exit from the right-eye pixel R of the display panel 10, which proceeds along the path toward the right eye of the user.

For example, as shown in FIG. 5, the parallax barrier 100 may be placed to be adjacent to the front side of the display panel 10.

With the aforementioned structure, the parallax barrier 100 provide a function that may divide the path of the light irradiated from the light source module into a path for the light to pass the left-eye pixel L and a path for the light to pass the right-eye pixel R and that creates binocular parallax as the user recognizes images for the left eye and the right eye, separately.

Although the display apparatus 1 of the non-emissive type is described with reference to FIGS. 3 to 5 as an example according to one or more embodiments of the disclosure, the disclosure is not limited thereto. For example, the display apparatus according to the disclosure may include a self-luminous type display apparatus, and the display panel of the self-luminous type display apparatus emits light autonomously, so the parallax barrier may be arranged in front of the display panel.

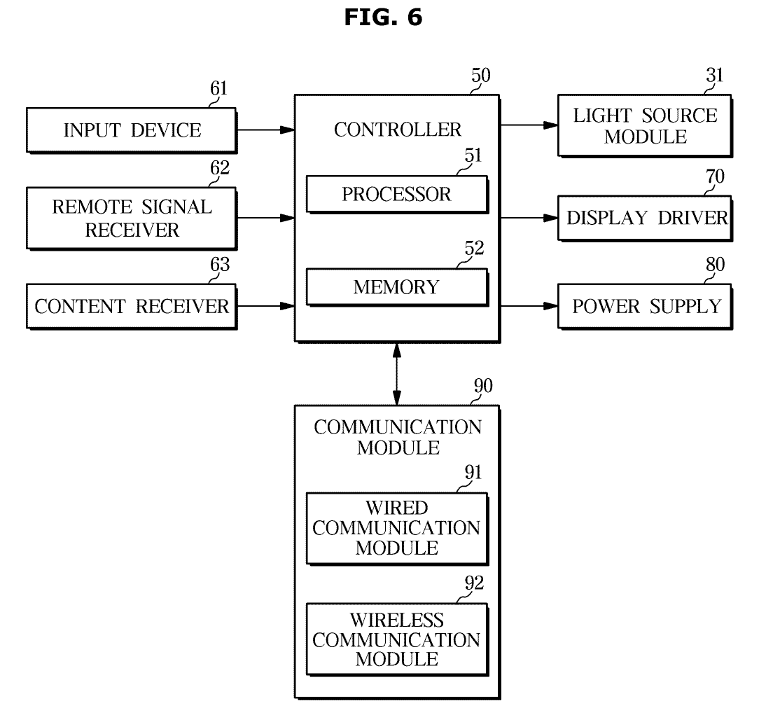

FIG. 6 is a block diagram illustrating a configuration of a display apparatus, according to one or more embodiments of the disclosure.

Referring to FIG. 6, the display apparatus 1 may include an input device 61. The input device 61 may receive a user input. The input device 61 may include a plurality of input buttons. Different input buttons of the input device 61 may obtain different user inputs. For example, the input device 61 may include a power button for turning on or off the display apparatus 1, a volume button for controlling audio volume, a content button for selecting a type of a content image, etc.

The input device 61 may receive a user input and output an electric signal (voltage or current) corresponding to the user input to a processor 51. The processor 51 may receive the user input based on an output signal of the input device 61.

The input device 61 may include various types of input devices such as a tact switch, a push switch, a slide switch, a toggle switch, a micro switch, or a touch switch.

The display apparatus 1 may include a remote signal receiver 62 for receiving a remote signal from an external input device (not shown). The remote signal receiver 62 may receive an infrared signal or a radio signal from the external input device. For example, the remote signal receiver 62 may include a photo diode for receiving the infrared signal or a receive antenna for receiving the radio signal.

For example, the external input device (not shown) may be arranged separately from the display apparatus 1. The external input device may obtain a user input and output a remote control signal (e.g., an infrared signal or a radio signal) corresponding to the obtained user input.

The remote signal receiver 62 may obtain the remote control signal by decoding the infrared signal or the radio signal received from the external input device, and provide an electric signal corresponding to the remote control signal (e.g., a voltage signal or a current signal) to the processor 51.

For example, types of the user input that may be input through the external input device and received by the remote signal receiver 62 may include an input to power on/off the display apparatus 1, an input to adjust audio volume, an input to select a type of content image, etc.

The display apparatus 1 may include a content receiver 63 for receiving content data from content sources. The content receiver 63 may receive video data and/or audio data from the content sources.

The content receiver 63 may include one or more receiving terminals for receiving content data from the content sources. For example, the content receiver 63 may include various types of terminals such as a component (YPbPr/RGB) terminal, a composite video blanking and sync (CVBS) terminal, an audio terminal, a high definition multimedia interface (HDMI) terminal, a universal serial bus (USB) terminal, etc.

The display apparatus 1 may include a communication module 90 for performing communication with an external device (not shown). The communication module 90 may receive content data from a content source connected to a network.

The communication module 90 may include a wired communication module 91 for receiving content data from a content source through a cable and a wireless communication module 92 for receiving content data from a content source wirelessly.

The wired communication module 91 may use various wired communication standards to receive a data stream from a content source. For example, the wired communication module 91 may use Ethernet, the IEEE 802.3 technology standard to receive video/audio data from the content source.

The wired communication module 91 may include a communication circuit (e.g., a wired communication interface controller) including a wired communication terminal for wiredly accessing a network, a processor for modulating and/or demodulating data for wired communication, and/or a memory.

The wireless communication module 92 may exchange wireless signals with an audio device based on various radio communication standards. Furthermore, the wireless communication module 92 may receive a data stream from a content source through the audio device.

For example, the wireless communication module 92 may use wireless fidelity (Wi-Fi, an IEEE 802.11 technology standard) radio communication to access a wireless repeater and receive video/audio data from a content source through the repeater.

The Wi-Fi radio communication may provide peer-to-peer communication between nodes without going through the wireless repeater. Such a Wi-Fi radio communication based peer-to-peer communication is referred to as “Wi-Fi P2P” or “Wi-Fi Direct”. The wireless communication module 92 may use the Wi-Fi P2P communication standard to exchange data with the external device.

Furthermore, the wireless communication module 92 may use Bluetooth, which is the IEEE 802.15.1 technology standard, or ZigBee, which is the IEEE 802.15.4 technology standard to exchange data with the audio device 200. Alternatively, the wireless communication module 92 may use near field communication (NFC) to exchange data with the external device.

The wireless communication module 92 may include a communication circuit (e.g., a wireless communication interface controller) including an antenna for transmitting or receiving wireless signals, a processor for decoding and/or encoding data for wireless communication, and/or a memory.

As such, the display apparatus 1 may receive content data from content sources through the content receiver 63 to the communication module 90.

The display apparatus 1 may include a display driver 70 for driving the display panel 10. The display apparatus 1 may reconstruct a plurality of image frames included in the content data and display the plurality of image frames successively. The display driver 70 may convert each of the reconstructed plurality of image frames to an analog image signal (hereinafter, referred to as a display driving signal) to be displayed on the display panel 10, and send the analog image signal to the display panel 10.

The display driver 70 may send the display driving signal to each of the plurality of pixels included in the display panel 10. Each of the plurality of pixels of the display panel 10 may emit a ray according to the display driving signal, and rays emitted from the plurality of pixels may be combined into one image. In other words, the display panel 10 may emit light based on the display driving signal received from the display driver 70, and display a content image corresponding to the display driving signal.

For example, the display driver 70 may send the display driving signal for displaying a 2D image to each of the plurality of pixels included in the display panel 10. The display panel 10 may display a 2D image formed by combining the light emitted from the left-eye pixels L and the light emitted from the right-eye pixels R based on receiving, from the display driver 70, the display driving signal for displaying the 2D image.

Alternatively, for example, the display driver 70 may send the display driving signal for displaying a 3D image to each of the plurality of pixels included in the display panel 10. Specifically, the display driver 70 may send a display driving signal for displaying an image for the left eye to the left-eye pixels L of the display panel 10 and send a display driving signal for displaying an image for the right eye to the right-eye pixels R of the display panel 10. In other words, the display panel 10 may display images for the left eye and the right eye, separately, based on receiving the display driving signal for displaying the 3D image from the display driver 70.

The display apparatus 1 may include a power supply 80 arranged to supply power for driving the parallax barrier 100. The power supply 80 may be arranged to apply an electric field to the parallax barrier 100.

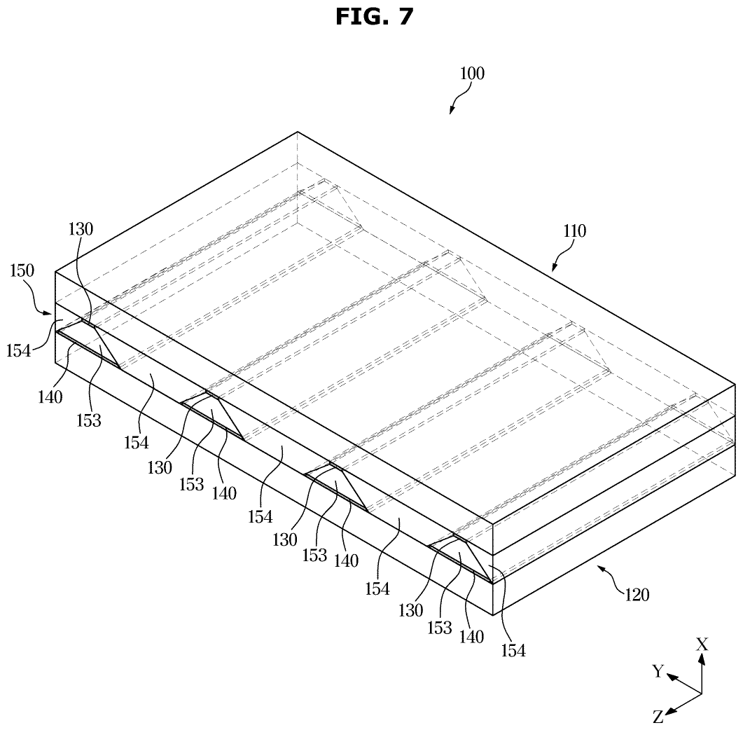

Specifically, the power supply 80 may be electrically connected to electrodes 130 and 140 (see FIG. 7) of the parallax barrier 100. The power supply 80 may generate an electric potential difference between the electrodes 130 and 140 of the parallax barrier 100. Due to the electric potential difference formed between the electrodes 130 and 140, an electric field may be applied to switching cells 153 of the parallax barrier 100. Operation of the parallax barrier 100 will be described later in detail.

The display apparatus 1 may include a controller 50 for controlling many different components of the display apparatus 1.

The controller 50 may include a processor 51 for generating a control signal for an operation of the display apparatus 1, and a memory 52 for storing a program, an application, instructions and/or data for the operation of the display apparatus 1. The processor 51 and the memory 52 may be implemented with separate semiconductor devices or in a single semiconductor device.

Furthermore, the controller 50 may include a plurality of processors or a plurality of memories. The controller 50 may be arranged in various positions inside the display apparatus 1. For example, the controller 50 may be included in a printed circuit board (PCB) arranged in an input device 510, an electromechanical parts module (not shown), etc., of the display apparatus 1.

The processor 51 may include an operation circuit, a storage circuit, and a control circuit. The processor 51 may include one or multiple chips. Furthermore, the processor 51 may include one or multiple cores.

The processor 51 may process data and/or a signal based on the program provided from the memory 52, and transmit a control signal to each component of the display apparatus 1 based on the processing result. For example, the processor 51 may process the content data and control the display apparatus 1. For example, the processor 51 may process a user input received through the input device 61 of the display apparatus 1 or a remote signal receiver 62. The processor 51 may output control signals to control various components of the display apparatus 1 such as the light source module (e.g., the light source 31, the display driver 70, the power supply 80, etc.) in response to the user input.

The components of the display apparatus 1 such as the light source module 31, the display driver 70, the power supply 80, etc., may be operated based on the control signal of the processor 51.

The memory 52 may store a program and data for processing content data, and temporarily store temporary data generated in processing the content data.

The memory 52 may include a volatile memory, such as a static random access memory (S-RAM) or a dynamic RAM (D-RAM), and a non-volatile memory, such as a read only memory (ROM) or an erasable programmable ROM (EPROM). The memory 52 may include a memory device, or multiple memory devices.

The processor 51 may restore a plurality of image frames and audio signals from the content data received through the content receiver 63 and/or the communication module 90 by decoding the received content data. The plurality of image frames may be displayed on the display panel 10. Sound from the audio signal may be output through a speaker (not shown).

The processor 51 may receive content data from a content source through the content receiver 63 and/or the communication module 90. The processor 51 may generate an image frame including a content image associated with the content data.

The processor 51 may receive a signal corresponding to a user input from the input device 61. Alternatively, the processor 51 may receive a remote control signal corresponding to a user input from an external input device (not shown) through the remote signal receiver 62. The processor 51 may change the type of the content image to be displayed on the display panel 10 based on the user input received from the input device 61 or the remote signal receiver 62.

An example of the processor 51 for controlling the components of the display apparatus 1 will now be described.

The processor 51 may control general operations of the display panel 10. Specifically, the processor 51 may be electrically connected to the display driver 70, and control the operation of the display panel 10 through the display driver 70 to display an image on the display panel 10. The display driver 70 may send the display driving signal to the display panel 10 based on the control signal received from the processor 51.

For example, the processor 51 may control the display driver 70 to send a display driving signal corresponding to a 2D image to the pixels of the display panel 10 based on an electric signal for providing the 2D image. In this case, the processor 51 may control the display panel 10 to provide the 2D image through a combination of rays emitted from the left-eye pixels L and the right-eye pixels R.

Alternatively, for example, the processor 51 may control the display driver 70 to send a display driving signal corresponding to a 3D image to the pixels of the display panel 10 based on an electric signal for providing the 3D image. Specifically, the processor 51 may control the display driver 70 to send a display driving signal corresponding to an image for the left eye to the left-eye pixels L and send a display driving signal corresponding to an image for the right eye to the right-eye pixels R based on an electric signal for providing a 3D image. In this case, the processor 51 may control the display panel 10 to provide the image for the left eye through a combination of rays emitted from the left-eye pixels L and simultaneously, provide the image for the right eye through a combination of rays emitted from the right-eye pixels R.

The processor 51 may control the light source module of the display apparatus 1. For example, the light source module of the display apparatus 1 may be configured to include the light guide plate 20 and the light source 31, and the processor 51 may control the light source 31 to irradiate light.

The processor 51 may control the operation of the parallax barrier 100. For example, the processor 51 may control the parallax barrier 100 to form an electric potential difference between the first and second electrodes 130 and 140 (see FIG. 7) arranged in the parallax barrier 100 under a certain condition. Alternatively, for example, the processor 51 may control the parallax barrier 100 not to form the electric potential difference between the first electrode 130 and the second electrode 140 under a certain condition.

Specifically, the processor 51 may be electrically connected to the power supply 80, and the power supply 80 may be electrically connected to each of the first electrode 130 and the second electrode 140 of the parallax barrier 100. In this case, the processor 51 may control the power supply 80 to form the electric potential difference between the first electrode 130 and the second electrode 140 under a certain condition. Alternatively, the processor 51 may control the power supply 80 not to form the electric potential difference between the first electrode 130 and the second electrode 140 under a certain condition.

The configuration of the display apparatus 1 as described above is merely an example of a display apparatus according to an aspect of the disclosure, without being limited thereto.

A configuration and operation of the parallax barrier 100 arranged to transmit or selectively block light when a 2D image or a 3D image is provided through the display panel 10 in the display apparatus 1 according to one or more embodiments of the disclosure will now be described in detail.

Furthermore, for convenience of explanation, a content image displayed on the display panel 10 when a 2D image is provided to the user is referred to as a first type of content image, and a content image displayed on the display panel 10 when a 3D image is provided to the user is referred to as a second type of content image. The first type of content image may be formed by including only one of an image for the left eye or an image for the right eye. Alternatively, the first type of content image may be formed by including an image different from the images for the left and right eyes. The second type of content image may be formed by including an image for the left eye and an image for the right eye.

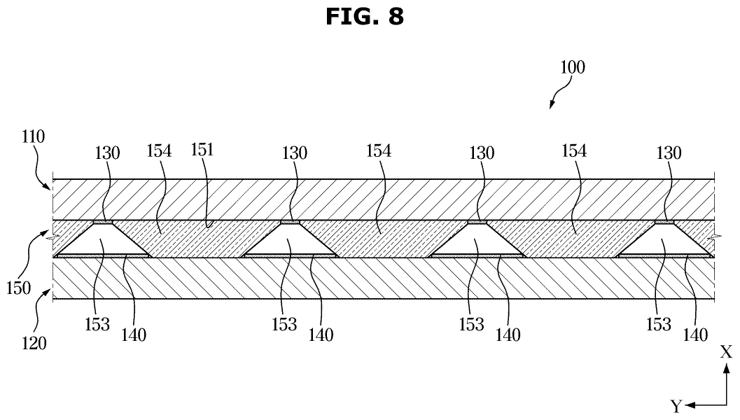

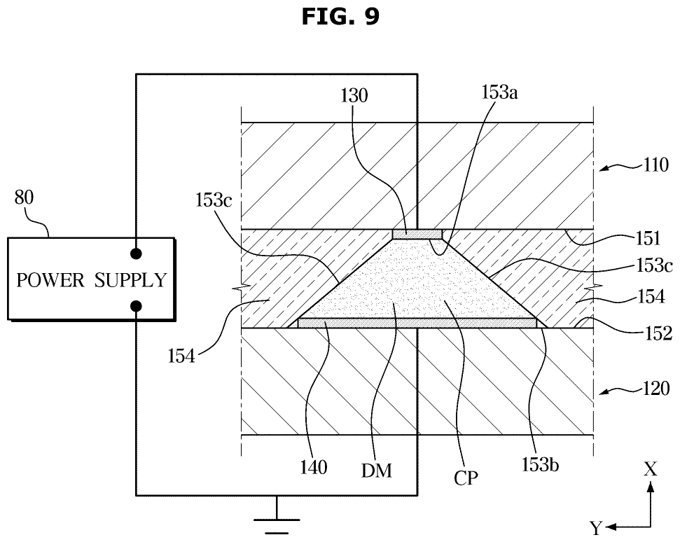

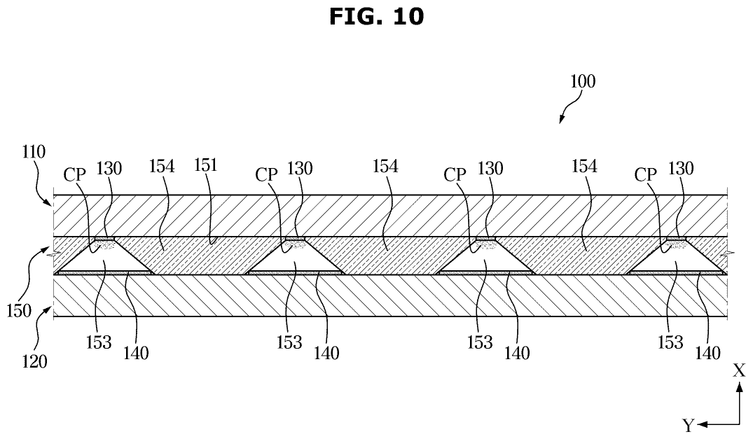

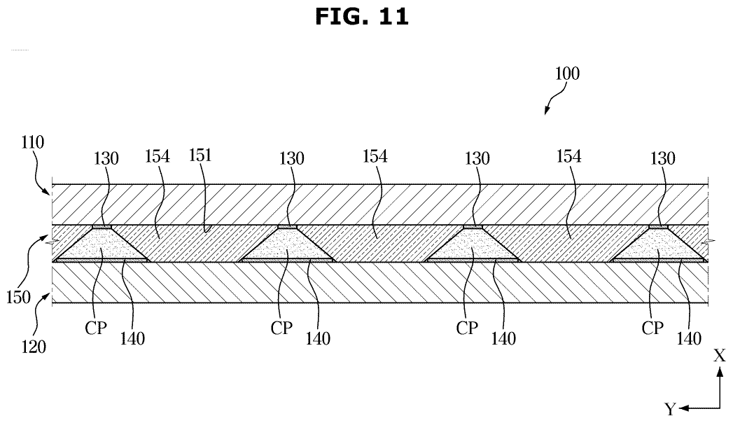

FIG. 7 is a perspective view of a parallax barrier of a display apparatus, according to one or more embodiments of the disclosure. FIG. 8 is a cross-sectional view of a parallax barrier of a display apparatus, according to one or more embodiments of the disclosure. FIG. 9 is an enlarged view of some components of a parallax barrier of a display apparatus, according to one or more embodiments of the disclosure. FIG. 10 is a cross-sectional view of a parallax barrier of a display apparatus in a transmitting mode, according to one or more embodiments of the disclosure. FIG. 11 is a cross-sectional view of a parallax barrier of a display apparatus in a blocking mode, according to one or more embodiments of the disclosure.

Referring to FIGS. 7 and 11, the display apparatus 1 according to one or more embodiments of the disclosure may include the parallax barrier 100. The parallax barrier 100 may selectively perform an operation for transmitting light irradiated from the light source module of the display apparatus 1 (hereinafter, referred to as a transmitting mode), and an operation for blocking a portion of light irradiated from the light source module (hereinafter, referred to as a blocking mode).

The parallax barrier 100 may include a switching cell 153 arranged to transmit or block light.

When the switching cell 153 transmits the light, light transmittance of the parallax barrier 100 may increase and the parallax barrier 100 may perform the transmitting mode. In the transmitting mode, the light irradiated from the light source module may be transmitted through the switching cell 153, and a path of the light irradiated from the light source module may hardly be affected or a little affected by the switching cell 153 (see FIG. 10).

On the other hand, when the switching cell 153 blocks the light, the parallax barrier 100 may block a portion of the light and perform the blocking mode. In the blocking mode, some of the paths of light irradiated from the light source module may be blocked by the switching cell 153. Specifically, the switching cell 153 may be arranged to divide the path of light irradiated from the light source module into a path of light to pass the left-eye pixel of the display panel 10 and a path of light to pass the right-eye pixel (see FIG. 11).

The switching cell 153 may have a space where charged particles CP and a dispersion medium DM are accommodated.

In the switching cell 153, the charged particles CP may be movably accommodated. The charged particles CP may include organic or inorganic particles (polymers or colloids) that have the property of moving by an electric field. When the electric field is applied inside the switching cell 153, the charged particles CP may be moved in the switching cell 153 in a direction of electric force applied by the electric field. When no electric field is applied inside the switching cell 153, the charged particles CP may be dispersed throughout the switching cell 153 over time.

The charged particles CP may be formed of a light-blocking material. The charged particles CP may each be provided to block the progress of a portion of light irradiated from the light source module. For example, the charged particles CP may be comprised of a black pigment such as aniline black or carbon black, etc., that absorbs light. Alternatively, the charged particles CP may be comprised of particles that scatter or reflect light.

The switching cell 153 may include the dispersion medium DM accommodated in the switching cell 153. The internal space of the switching cell 153 may be filled with the dispersion medium DM. The dispersion medium DM may be provided to transmit light. In other words, the dispersion medium DM may be formed to include a material with high light transmittance.

The charged particles CP may be mixed with the dispersion medium DM and accommodated in the switching cell 153, and may be movable in the switching cell 153 by the dispersion medium DM. When no electric field is applied inside the switching cell 153, the charged particles CP may be dispersed in the dispersion medium DM. When an electric field is applied inside the switching cell 153, the charged particles CP dispersed in the dispersion medium DM may be moved in a direction of electric force applied by the electric field.

The dispersion medium DM may be formed in a liquid state or a gaseous state. To avoid sedimentation of the charged particles CP due to gravity, the relative density of the dispersion medium DM and the relative density of electrophoretic particles 137 may be set to be almost the same. For example, the dispersing medium (DM) may be comprised of various types of materials such as an alcohol solvent such as water, methanol, ethanol, isopropanol, butanol, octanol, methyl cellulose, etc., various esters such as ethyl acetate, butyl acetate, ketones such as acetone, methyl ethyl ketone, methyl isobutyl ketone, etc., aliphatic hydrogen oxides such as pentane, hexane, octane, etc., alicyclic hydrocarbons such as cyclohexane, methylcyclohexane, etc., aromatic hydrocarbons such as benzene with a long-chain alkyl group including tetradecylbenzene, benzene, toluene, xylene, hexylbenzene, heptylbenzene, octylbenzene, nonylbenzene, decylbenzene, undecylbenzene, dodecylbenzene, tridecylbenzene, etc., halogenated hydrocarbons such as methylene chloride, chloroform, carbon tetrachloride, 1,2-dichloroethane, etc., carbonate, or other various oils alone or a mixture thereof, which is blended with surfactants, etc. It is not limited thereto, and the dispersion medium DM may be composed of various types of materials characterized by transmitting light and allowing the charged particles CP to be movable in a state of being mixed with the dispersion medium DM.

The parallax barrier 100 may include the first electrode 130 and the second electrode 140. The first electrode 130 and the second electrode 140 may face each other. For example, the first electrode 130 and the second electrode 140 may be arranged to face each other in the front-back direction of the display apparatus 1.

The first electrode 130 and the second electrode 140 may each be electrically connected to the power supply 80. Depending on the operation of the power supply 80, an electric potential difference may or may not be generated between the first electrode 130 and the second electrode 140.

According to the electric potential difference generated between the first electrode 130 and the second electrode 140, an electric field may be applied between the first electrode 130 and the second electrode 140. According to the electric field applied between the first electrode 130 and the second electrode 140, electric force directed to one of the first electrode 130 and the second electrode 140 may be applied to the charged particles CP. The type of charge assumed by the charged particles CP and the electric potential difference formed between the first electrode 130 and the second electrode 140 may be variously set according to the direction in which to move the charged particles CP.

The first electrode 130 and the second electrode 140 may be formed of a conductive material.

The first electrode 130 may be provided to transmit light. The first electrode 130 may be formed as a transparent electrode. For example, the first electrode 130 may be formed to include a material such as indium tin oxide (ITO) or indium zinc oxide (IZO). It is not, however, limited thereto, and the first electrode 130 may be formed to include various materials.

The second electrode 140 may be provided to transmit light. The second electrode 140 may be formed as a transparent electrode. For example, the second electrode 140 may be formed to include a material such as indium tin oxide (ITO) or indium zinc oxide (IZO). It is not, however, limited thereto, and the second electrode 140 may be formed to include various materials.

As shown in FIG. 9, the second electrode 140 may be connected to the ground. It is not, however, limited thereto, and the second electrode 140 may not be connected to the ground, or instead of the second electrode 140, the first electrode 130 may be connected to the ground. The first electrode 130 and the second electrode 140 may be variously formed to generate an electric potential difference between the first electrode 130 and the second electrode 140 according to an operation of the power supply 80.

The parallax barrier 100 may include the first substrate 110 and the second substrate 120 each provided to transmit light.

The first substrate 110 and the second substrate 120 may be arranged ahead of the light source module (e.g., the light guide plate 20) of the display apparatus 1. The first substrate 110 and the second substrate 120 may each be provided to transmit light irradiated from the light source module.

The first substrate 110 and the second substrate 120 may be placed to face each other. For example, the first substrate 110 and the second substrate 120 may be placed to face each other in the front-back direction as shown in FIGS. 7 to 11. For example, the first substrate 110 may be placed in front of the second substrate 120, such that the second substrate 120 is between the flight source module and the first substrate 110.

The first substrate 110 and the second substrate 120 may extend in parallel with each other. The first substrate 110 and the second substrate 120 may extend in parallel with the display panel 10. For example, the first substrate 110 and the second substrate 120 may have the form of a flat plate. The first substrate 110 and the second substrate 120 may have the shape that corresponds to the display panel 10.

The first substrate 110 may be formed as a transparent substrate. For example, the first substrate 110 may be formed to include a glass material or a transparent plastic material such as polymethyl methacrylate (PMMA), poly carbonate (PC), etc. Alternatively, the first substrate 110 may be formed to include polydimethylsiloxane as a flexible transparent film material. It is not, however, limited thereto, and the first substrate 110 may be formed to include various materials.

The second substrate 120 may be formed as a transparent substrate. For example, the second substrate 120 may be formed to include a glass material or a transparent plastic material such as polymethyl methacrylate (PMMA), poly carbonate (PC), etc. Alternatively, the second substrate 120 may be formed to include polydimethylsiloxane as a flexible transparent film material. It is not, however, limited thereto, and the second substrate 120 may be formed to include various materials.

The first electrode 130 may be connected to the first substrate 110. The first electrode 130 may be electrically connected to the power supply 80 through the first substrate 110.

The first electrode 130 may be arranged on the first substrate 110. For example, the first electrode 130 may be arranged on one side of the first substrate 110. Specifically, the first electrode 130 may be arranged on a side of the first substrate 110 that faces the second substrate 120, and for example, the side of the first substrate 110 may be a rear side of the first substrate 110 as shown in FIGS. 7 to 11.

For example, the first electrode 130 may be formed on the first substrate 110 by various methods such as chemical vapor deposition (CVD), plasma enhanced CVD (PECVD), low pressure CVD (LPCVD), physical vapor deposition (PVD), sputtering, atomic layer deposition (ALD), etc.

The second electrode 140 may be connected to the second substrate 120. The second electrode 140 may be electrically connected to the power supply 80 through the second substrate 120. As shown in FIG. 9, when the second electrode 140 is connected to the ground, the second electrode 140 may be connected to the ground through the second substrate 120.

The second electrode 140 may be arranged on the second substrate 120. For example, the second electrode 140 may be arranged on one side of the second substrate 120. Specifically, the second electrode 140 may be arranged on a side of the second substrate 120 that faces the first substrate 110, and for example, the side of the second substrate 120 may be a front side of the second substrate 120 as shown in FIGS. 7 to 11.

For example, the second electrode 140 may be formed on the second substrate 120 by various methods such as chemical vapor deposition (CVD), plasma enhanced CVD (PECVD), low pressure CVD (LPCVD), physical vapor deposition (PVD), sputtering, atomic layer deposition (ALD), etc.

The parallax barrier 100 may include a switching layer 150 arranged to transmit light or selectively block light. The switching layer 150 may operate in a transmitting mode to transmit light irradiated from the light source module, or operate in a blocking mode to selectively block a portion of the light irradiated from the light source module depending on the path of the light. The switching layer 150 may include the aforementioned switching cell 153.

The switching layer 150 may be arranged between the first substrate 110 and the second substrate 120. The switching layer 150 may be placed in parallel with each of the first substrate 110 and the second substrate 120. The switching layer 150 may extend in parallel with the display panel 10. The switching layer 150 may have the shape that corresponds to the shape of the display panel 10.

The switching layer 150 may include a plurality of switching cells 153. A plurality of switching cells 153 may be arranged in parallel with the switching layer 150. In other words, the plurality of switching cells 153 may be arranged in the switching layer 150 in a direction parallel to an extending direction of the display panel 10, and specifically, the plurality of switching cells 153 may be arranged in the switching layer 150 to one side of the extending direction of the display panel 10. The extending direction of the switching layer 150 or the extending direction of the display panel 10 refers to a direction parallel to the Y-Z plane with respect to the drawings, i.e., a direction perpendicular to the front-back direction of the display apparatus 1.

The plurality of switching cells 153 may be arranged in various directions depending on a direction in which the user generally looks at the display apparatus 1.

For example, as shown in FIG. 7, the plurality of switching cells 153 may be arranged in a direction of the long side (direction Y or left-right direction) of the display panel 10.

The plurality of switching cells 153 may extend in parallel with each other. Each of the plurality of switching cells 153 may extend in a direction perpendicular to the direction in which the plurality of switching cells 153 are arranged. For example, as shown in FIG. 7, the plurality of switching cells 153 may extend in the direction of the short side (direction Z or vertical direction) of the display panel 10.

In a case that the long side of the display panel 10 lies in parallel with the left-right direction of the display apparatus 1, the plurality of switching cells 153 are arranged in the direction of the long side of the display panel 10, giving the user a 3D effect more efficiently.

It is not, however, limited thereto, and the plurality of switching cells 153 may be arranged in the direction of the short side of the display panel 10.

In the switching layer 150, the plurality of switching cells 153 may be arranged separately.

For example, the plurality of switching cells 153 may be arranged at regular intervals. In this case, design and manufacturing processes of the parallax barrier 100 may be streamlined, manufacturing time and costs may be reduced, and an error rate in arranging the switching cells 153 may be reduced.

It is not, however, limited thereto, and the plurality of switching cells 153 may be arranged at different intervals. For example, when the angle at which the user views the display panel 10 may be diversified as in the case that the horizontal length of the display panel 10 of the display apparatus 1 is long, the plurality of switching cells 153 may be arranged at different intervals to provide a uniform binocular parallax effect regardless of the angle at which the user views the display panel 10.

Although there are four switching cells 153 included in the switching layer 150 in FIGS. 7 to 11, it is merely for convenience of illustration and the disclosure is not limited thereto.

The switching layer 150 may include a transmission portion 154 provided to transmit light. The transmission portion 154 may be provided to transmit light irradiated forward from the light source module. The transmission portion 154 may be arranged between the plurality of switching cells 153.

The transmission portion 154 may transmit light irradiated from the light source module no matter whether the parallax barrier 100 operates in the transmitting mode or blocking mode.

The transmission portion 154 may be formed to include a material with high light transmittance. For example, the transmission portion 154 may be formed to include a transparent plastic material. As will be described later, the transmission portion 154 may be manufactured in a way of hardening a plastic resin by ultraviolet rays or thermal treatment.

The transmission portion 154 may be formed of a material having a refraction index corresponding to the dispersion medium DM. The transmission portion 154 may be formed of a material having a refraction index equal to or almost similar to the dispersion medium DM. Accordingly, as shown in FIG. 10, in the transmitting mode, the light transmitted through the switching cell 153 and the light transmitted through the transmission portion 154 may be evenly proceeded, or the light transmitted through the switching cell 153 may reduce the refraction degree of the light while entering the transmission portion 154.

The transmission portion 154 may be formed to include an insulation material.

As shown in FIG. 10, when the switching cell 153 is to perform the transmitting mode to transmit light, an electric potential difference may be formed between the first electrode 130 and the second electrode 140 and an electric field may be applied between the first electrode 130 and the second electrode 140 according to the electric potential difference. Specifically, the electric field may be applied between the first electrode 130 and the second electrode 140 for the charged particles CP to receive electric force directed to the first electrode 130 and move to the first electrode 130 in the switching cell 153.

For example, when the second electrode 140 is connected to the ground (i.e., the electric potential is 0V), the first electrode 130 may assume opposite charges to the charged particles CP. The charged particles CP may move toward the first electrode 130 according to electrical attraction. They are not, however, limited thereto, and the charged particles CP may assume charges with the same polarity as the second electrode 140, and accordingly, move toward the second electrode 140 according to electric repulsive force with the second electrode 140.

As shown in FIG. 10, the charged particles CP in the switching cell 153 may move toward the first electrode 130 according to the electric field applied between the first electrode 130 and the second electrode 140, and when the charged particles CP are concentrated near the first electrode 130, the switching cell 153 may have increasing light transmissivity. In other words, the switching cell 153 may operate in the transmitting mode to transmit light irradiated from the light source module.

Specifically, as will be described below, the switching cell 153 may have a form in which one end 153a (hereinafter, referred to as a first end) at which the first electrode 130 is located is narrower in width than the other end 153b (hereinafter, referred to as a second end) at which the second electrode 140 is located. Hence, when the electric field is applied between the first electrode 130 and the second electrode 140, the charged particles CP may move toward the first electrode 130, and may be concentrated at the first end 153a of the switching cell 153, narrowing an area in which the switching cell 153 blocks light.

Characteristics of the form of the switching cell 153 will be described in detail later.

As shown in FIG. 11, when the switching cell 153 is to perform the blocking mode to block light, no electric potential difference may be formed between the first electrode 130 and the second electrode 140. In other words, no electric field may be applied between the first electrode 130 and the second electrode 140 in the blocking mode.

When no electric field is applied between the first electrode 130 and the second electrode 140, the charged particles CP in the switching cell 153 may be evenly mixed with the dispersion medium DM by dispersion as shown in FIG. 11. Accordingly, the charged particles CP may be evenly distributed in the switching cell 13, and the switching cell 153 may have an increasing light blocking ratio. In other words, the switching cell 153 may operate in the blocking mode to block light irradiated from the light source module.

As such, when the operation of the switching cell 153 is switched to the transmitting mode from the blocking mode, an electric field may be applied between the first electrode 130 and the second electrode 140 so that the charged particles CP move to the first electrode 130. Furthermore, when the operation of the switching cell 153 is switched to the blocking mode from the transmitting mode, the electric field applied between the first electrode 130 and the second electrode 140 may be removed to diffuse the charged particles CP in the switching cell 153. Depending on whether an electric field is applied between the first electrode 130 and the second electrode 140, the operation of the switching cell 153 may be selectively controlled to transmit or block light.

Moreover, for example, when the operation of the switching cell 153 is switched to the blocking mode from the transmitting mode, prior to the removing of the electric field applied between the first electrode 130 and the second electrode 140, an electric field of an opposite direction may be applied between the first electrode 130 and the second electrode 140 for a certain time. Specifically, in order to apply electric force for the charged particles CP to move toward the second electrode 140 from the first electrode 130, an electric field of an opposite direction to that in the transmitting mode may be applied between the first electrode 130 and the second electrode 140 for a certain time. After a lapse of the certain time for which the electric field of the opposite direction is applied, the electric field may be removed from between the first electrode 130 and the second electrode 140. With this procedure, the time spent switching the switching cell 153 to the blocking mode from the transmitting mode may be reduced.

In the transmitting mode for the switching cell 153 to transmit light, the processor 51 may control the parallax barrier 100 to form an electric potential difference between the first electrode 130 and the second electrode 140 to move the charged particles CP to an end of the switching cell 153 at which the first electrode 130 is located. In other words, the processor 51 may control the power supply 80 to apply an electric field to apply electric force directed to the first electrode 130 to the charged particles CP in the switching cell 153, based on an electric signal to perform the transmitting mode for the switching cell 153 to transmit light.

The processor 51 may control the parallax barrier 100 not to form the electric potential difference between the first electrode 130 and the second electrode 140 in the blocking mode for the switching cell 153 to block light. Specifically, the processor 51 may control the power supply 80 not to apply an electric field between the first electrode 130 and the second electrode 140, based on an electric signal for the switching cell 153 to perform the blocking mode to block light.

As shown in FIG. 11, when the switching cell 153 operates in the blocking mode, the switching cell 153 may block a portion of light irradiated from the light source module and the parallax barrier 100 may selectively transmit the light irradiated from the light source module.

As described above, in the blocking mode, the parallax barrier 100 may divide the path of the light irradiated from the light source module into a path of light to pass the left-eye pixel L and a path of light to pass the right-eye pixel R. Accordingly, an image for the left eye formed by a combination of rays emitted from the left-eye pixels L and an image for the right eye formed by a combination of rays emitted from the right-eye pixels R may be provided to the user separately, giving a 3D effect for the user to recognize a 3D image through the image for the left eye and the image for the right eye.

In other words, in a case of displaying a second type of content image on the display panel 10 to provide a 3D image for the user, the parallax barrier 100 may operate in the blocking mode.

In the meantime, when the parallax barrier 100 operates in the blocking mode, light may be blocked by the switching cell 153 and accordingly, the screen brightness may be dark. Especially, when the parallax barrier 100 operates in the blocking mode even when a 2D image is to be provided for the user, the brightness of the display panel 10 may be unnecessarily reduced.

As shown in FIG. 10, when the switching cell 153 operates in the transmitting mode, the rate at which the switching cell 153 transmits the light irradiated from the light source module may increase, and light transmission ratio of the parallax barrier 100 may increase.

Accordingly, in providing a 2D image for the user through the display panel 10, the parallax barrier 100 may be arranged to operate in the transmitting mode, thereby preventing an unnecessary decrease in brightness of the display panel 10.

In other words, in a case of displaying a first type of content image on the display panel 10 to provide a 2D image for the user, the parallax barrier 100 may operate in the transmitting mode.

As such, the display apparatus 1 according to one or more embodiments of the disclosure may provide the user with a 2D image or a 3d image selectively depending on the operation mode of the parallax barrier 100. In one or more embodiments of the disclosure, in displaying the 2D image in particular, the display apparatus 1 may operate the parallax barrier 100 in the transmitting mode and thus, the brightness of the display panel 10 may be enhanced.

The processor 51 may control the parallax barrier 100 to form the electric potential difference between the first electrode 130 and the second electrode 140 based on an electric signal to display the first type of content image on the display panel 10. In other words, the processor 51 may control the power supply 80 to perform the transmitting mode based on receiving a first content signal to display the first type of content image.

The first content signal to display the first type of content image will be described later.

The processor 51 may control the parallax barrier 100 not to form a electric potential difference between the first electrode 130 and the second electrode 140 based on an electric signal to display the second type of content image on the display panel 10. In other words, the processor 51 may control the power supply 80 to perform the blocking mode based on receiving a second content signal to display the second type of content image.

The second content signal to display the second type of content image will be described later.

Forms of the switching layer 150 and switching cell 153 of the display apparatus 1 according to one or more embodiments of the disclosure will now be described in detail with reference to FIGS. 7 to 11.

The switching layer 150 may include a first surface 151 on which the first electrode 130 is arranged, and a second surface 152 on which the second electrode 140 is arranged. The first surface 151 and the second surface 152 may be opposite each other.

For example, the first surface 151 may be arranged on one side of the switching layer 150 that faces the first substrate 110. Specifically, the first surface 151 may be arranged on the front surface of the switching layer 150.

For example, the second surface 152 may be arranged on the other side of the switching layer 150 that faces the second substrate 120. Specifically, the second surface 152 may be arranged on the rear surface of the switching layer 150.

For example, the first surface 151 and the second surface 152 may face each other in the front-back direction of the display apparatus 1. The first surface 151 and the second surface 152 may each extend in parallel with the display panel 10. The first surface 151 and the second surface 152 may have a shape that corresponds to the display panel 10.

The switching cell 153 may be arranged between the first surface 151 and the second surface 152.

The first end 153a of the switching cell 153 may be located adjacent to the first surface 151. The second end 153b of the switching cell 153 may be located adjacent to the second surface 152.

For example, the first end 153a may correspond to the front end of the switching cell 153 and the second end 153b may correspond to the rear end of the switching cell 153.

The switching cell 153 may have a form having decreasing width in a direction parallel to the extending direction of the first surface 151 toward the first surface 151. In other words, the switching cell 153 may have a form having decreasing width in a direction parallel to the extending direction of the first surface 151 toward the first end 153a. The extending direction of the first surface 151 refers to a direction parallel to the Y-Z plane with respect to the drawings, i.e., at least one of directions perpendicular to the front-back direction of the display apparatus 1.

The width in the direction parallel to the extending direction of the first surface 151 of the switching cell 153 may refer to width in a direction parallel to the display panel 10 (width in the Y direction with respect to the drawings).

When the electric field is applied between the first electrode 130 and the second electrode 140, the charged particles CP may move toward the first surface 151 according to electric force. The charged particles CP may move to an area with gradually decreasing width in the switching cell 153, and the charged particles CP may be concentrated in a location adjacent to the first surface 151.

The switching cell 153 may include an inclined surface 153c arranged between the first surface 151 and the second surface 152. The inclined surface 153c may be arranged between the first end 153a and the second end 153b. The inclined surface 153c may be placed between the first electrode 130 and the second electrode 140.

The inclined surface 153c may be formed to be inclined to a direction perpendicular to each of the first surface 151 and the second surface 152. The inclined surface 153c may extend in a inclined direction to a direction (direction X with respect to the drawings) in which the first surface 151 and the second surface 152 face each other. The inclined surface 153c may be inclined in a different direction from the direction in which the first substrate 110 and the second substrate 120 face each other.

For example, the inclined surface 153c may be formed to have a certain slope, but is not limited thereto.

The inclined surface 153c may be formed on an inner surface of the switching cell 153. The inclined surface 153c may define edges of internal space of the switching cell 153. The dispersion medium DM and the charged particles CP in the switching cell 153 may come into contact with the inclined surface 153c.

When the charged particles CP move in the switching cell 153 according to an electric field applied between the first electrode 130 and the second electrode 140, the inclined surface 153c may perform a function of guiding the charged particles CP to be concentrated at the first end 153a. Specifically, the inclined surface 153c may guide the charged particles CP to move toward the first end 153a according to an electric field applied between the first electrode 130 and the second electrode 140, and simultaneously, guide the movement of the charged particles CP so that the charged particles CP may be gathered in a location adjacent to the first electrode 153a.

The inclined surface 153c may define a border between the switching cell 153 and the transmission portion 154.

The inclined surface 153c may be formed to be closer to the first electrode 130 (in the direction Y with respect to the drawings) in the extending direction of the first surface 151 when it goes to the first electrode 130 from the second electrode 140.

The switching cell 153 may be narrower in width on the first surface 151 than on the second surface 152. In other words, the width of the first end 153a may be narrower than the width of the second end 153b. Specifically, the switching cell 153 may have a shape that has decreasing width toward the first end 153a from the second end 153b.

The switching cell 153 may have a form that has decreasing width toward the first surface 151 from the second surface 152. In the drawings, for example, the switching cell 153 may have decreasing width of the direction Y toward the front in the direction X from the second surface 152 to the first surface 151.

The switching cell 153 may have a form that has decreasing width of a direction parallel to the first substrate 110 and the second substrate 120 from the second surface 152 to the first surface 151. The switching cell 153 may have a form that has decreasing width of a direction parallel to the first substrate 110 and the second substrate 120 from the second end 153b to the first end 153a.

For example, the first end 153a of the switching cell 153 may be formed to have width corresponding to the width of the first electrode 130. Furthermore, for example, the second end 153b of the switching cell 153 may be formed to have width corresponding to the width of the second electrode 140. The first electrode 130 may be formed to have width narrower than the second electrode 140.

The inclined surface 153c may connect the first end 153a to the second end 153b. The inclined surface 153c may extend from the first end 153a to the second end 153b. The inclined surface 153c may extend from the second surface 152 to the first surface 151.

As shown in FIG. 7, each switching cell 153 may extend in a direction parallel to the extending direction of the first surface 151 and the second surface 152 (direction Z parallel to the direction of the short side of the display panel 10 in the drawings). In this case, the inclined surface 153c of the switching cell 153 may extend in a direction in which the switching cell 153 extends.

The inclined surface 153c included in the single switching cell 153 may be provided in the plural. Specifically, each of the plurality of switching cells 153 may include a plurality of inclined surfaces 153c. The plurality of inclined surfaces 153c may be inclined in a direction different from the direction in which the first substrate 110 and the second substrate 120 face each other between the first end 151a and the second end 151b. The plurality of inclined surfaces 153c may be inclined in different directions.

The plurality of inclined surfaces 153c may be arranged to face each other in the single switching cell 153. The plurality of inclined surfaces 153c may extend to be closer to each other toward the first surface 151 in the single switching cell 153. The plurality of inclined surfaces 153c may extend to be closer to each other toward the first end 153a in the single switching cell 153. The plurality of inclined surfaces 153c may extend to be closer to each other toward the first electrode 130 in the single switching cell 153.

With this structure, when an electric field is applied between the first electrode 130 and the second electrode 140, the charged particles CP in the switching cell 153 may be concentrated in a location adjacent to the first end 153a, and the switching cell 153 may operate in the transmitting mode. Furthermore, when no electric field is applied between the first electrode 130 and the second electrode 140, the charged particles CP may be dispersed in the switching cell 153, and the switching cell 153 may operate in the blocking mode.

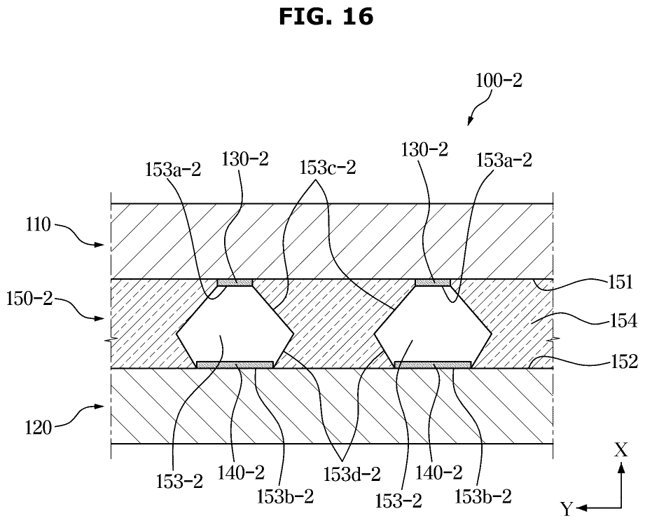

The aforementioned form of the switching cell 153 is merely an example of a form of a switching cell included in the parallax barrier of the display apparatus according to an aspect of the disclosure, without being limited thereto. For example, the switching cell may have a form that has decreasing width toward the first end from a certain location between the first end and the second end (see FIG. 16) instead of a form that has constantly increasing width of the switching cell toward the second end at which the second electrode is located from the first end at which the first electrode is located. Alternatively, for example, the switching cell may have a form that has decreasing width from the second end to a certain location between the first end and the second end and that has constant width from the certain location to the first end. Furthermore, the inclined surfaces of the switching cell may not be provided in a pair as shown in FIG. 11, and for example, one surface that connects the first end to the second end is an inclined surface and the other surface opposite the inclined surface may be a surface perpendicular to the first surface and the second surface.

An example of a method of manufacturing the parallax barrier 100 of the display apparatus 1 according to one or more embodiments of the disclosure will now be described.

To manufacture the parallax barrier 100 of the display apparatus 1, the first electrode 130 may be formed on the first substrate 110. A method of forming the first electrode 130 may include a method of forming the first electrode 130 through processes of coating and patterning a material such as ITO on one surface of the first substrate 110.

After this, a plastic resin may be applied on the one surface of the first substrate 110 on which the first electrode 130 is formed. Before hardening the plastic resin, an imprinting process may be performed by using a demolding device in a location at which to form the switching cell 153. The demolding device may be formed in a shape corresponding to the shape of the switching cell 153. After placing the demolding device in the location to form the switching cell 153, the switching layer 150 may be formed through a process of hardening the plastic resin. For example, the plastic resin may be hardened by ultraviolet irradiation or thermal treatment. The hardened plastic resin may make up the transmission portion 154. By removing the demolding device after the plastic resin is hardened, internal space of the switching cell 153 may be formed in the corresponding location.

After this, the dispersion medium DM and the charged particles CP may be filled in the internal space of the switching cell 153, and the second substrate 120 on which the second electrode 140 is formed may be attached to the switching layer 150. A method of forming the second electrode 140 on the second substrate 120 may be performed in the same way as the procedure for forming the first electrode 130 on the first substrate 110.

According to the aforementioned procedure, the parallax barrier 100 according to one or more embodiments may be manufactured. It is not, however, limited thereto, and the method of manufacturing the parallax barrier of the display apparatus according to an aspect of the disclosure may include various manufacturing steps.

According to the aforementioned method of manufacturing the parallax barrier 100, the first electrode 130 may be placed outside of the switching cell 153. For example, the first electrode 130 may be located between the first end 153a and the first surface 151 of the switching cell 153. Furthermore, the second electrode 140 may be placed inside the switching cell 153.

It is not, however, limited thereto, and for example, the first electrode 130 and the second electrode 140 may be located inside the switching cell 153. For example, in the imprinting process that forms the switching cell 153, as the demolding device has a corresponding shape to the first electrode 130, the switching cell 153 may be manufactured to have a shape that covers the first electrode 130 from outside.

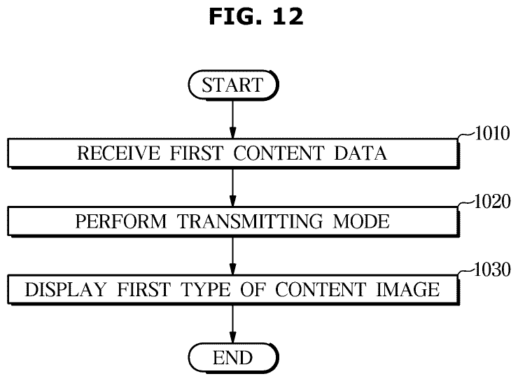

FIG. 12 is a flowchart illustrating a method of controlling a display apparatus, according to one or more embodiments of the disclosure.

In the display apparatus 1 according to one or more embodiments of the disclosure, a step in which the parallax barrier 100 performs the transmitting mode and a step in which the display panel 10 displays the first type of content image will be described as an example with reference to FIG. 12.

Referring to FIG. 12, the display apparatus 1 may receive first content data through the content receiver 63 or the communication module 90, in 1010. The first content data is content data corresponding to a first content image, and may include only data for displaying a 2D image. Specifically, the first content data may include only the data corresponding to an image for the left eye, only the data corresponding to an image for the right eye, or only the data corresponding to a 2D image which is different from the images for the left eye and the right eye.

The processor 51 may control the parallax barrier 100 to perform the transmitting mode in 1020 based on receiving the first content data from the content receiver 63 or the communication module 90. Specifically, the processor 51 may control the power supply 80 to perform the transmitting mode based on receiving the first content data.

Furthermore, the processor 51 may control the display panel 10 to display the first type of content image in 1030, based on receiving the first content data from the content receiver 63 or the communication module 90. Specifically, the processor 51 may control the display driver 70 to send a display driving signal corresponding to the first type of content image to the display panel 10 based on receiving the first content data.

Although it is shown in FIG. 12 that the performing of the transmitting mode in 1020 is followed by the displaying of the first type of content image in 1030, a method of controlling the display apparatus according to an aspect of the disclosure is not limited thereto. The performing of the transmitting mode in 1020 and the displaying of the first type of content image in 1030 may be almost simultaneously performed.

The aforementioned first content signal for displaying the first content image may be a signal output in response to receiving the first content data through the content receiver 63 or the communication module 90.

With these steps, the display apparatus 1 may provide a 2D image for the user.

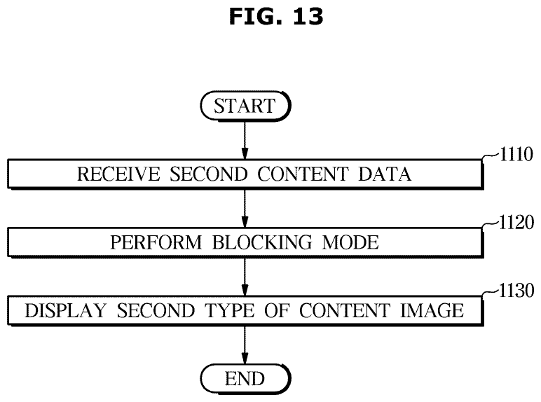

FIG. 13 is a flowchart illustrating a method of controlling a display apparatus, according to one or more embodiments of the disclosure.

In the display apparatus 1 according to one or more embodiments of the disclosure, a step in which the parallax barrier 100 performs the blocking mode and a step in which the display panel 10 displays the second type of content image will be described as an example with reference to FIG. 13.

Referring to FIG. 13, the display apparatus 1 may receive second content data through the content receiver 63 or the communication module 90, in 1110. The second content data is content data corresponding to a second content image, and may include data for displaying a 3D image. Specifically, the second content data may include both data corresponding to an image for the left eye and data corresponding to an image for the right eye.

The processor 51 may control the parallax barrier 100 to perform the blocking mode in 1120 based on receiving the second content data from the content receiver 63 or the communication module 90. Specifically, the processor 51 may control the power supply 80 to perform the blocking mode based on receiving the second content data.

Furthermore, the processor 51 may control the display panel 10 to display the second type of content image in 1130, based on receiving the second content data from the content receiver 63 or the communication module 90. Specifically, the processor 51 may control the display driver 70 to send a display driving signal corresponding to the second type of content image to the display panel 10 based on receiving the second content data. More specifically, the processor 51 may control the display panel 10 to display an image for the left eye through the left-eye pixels L and display an image for the right eye through the right-eye pixels R.

Although it is shown in FIG. 13 that the performing of the blocking mode in 1120 is followed by the displaying of the second type of content image in 1130, a method of controlling the display apparatus according to an aspect of the disclosure is not limited thereto. The performing of the blocking mode in 1120 and the displaying of the second type of content image in 1130 may be almost simultaneously performed.

The aforementioned second content signal for displaying the second content image may be a signal output in response to receiving the second content data through the content receiver 63 or the communication module 90.

With these steps, the display apparatus 1 may provide a 3D image for the user.

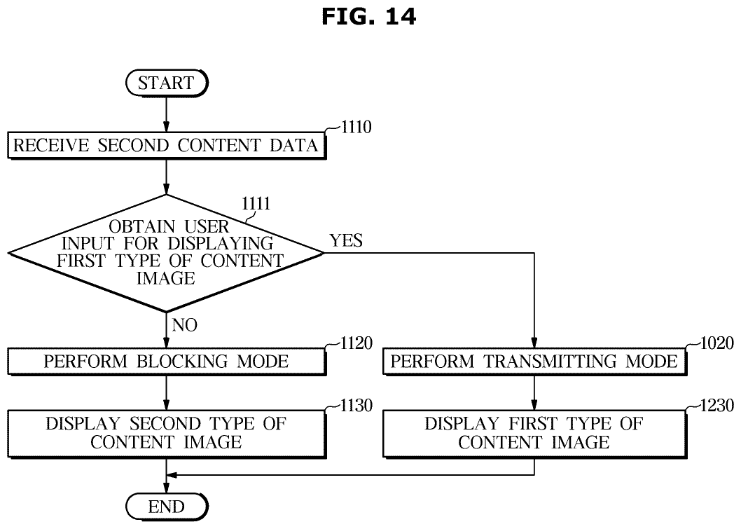

FIG. 14 is a flowchart illustrating a method of controlling a display apparatus, according to one or more embodiments of the disclosure.

In the display apparatus 1 according to one or more embodiments of the disclosure, a step in which the parallax barrier 100 performs the transmitting mode or the blocking mode according to a user input and a step in which the display panel 10 displays the first type or second type of content image will be described as an example with reference to FIG. 14.

Referring to FIG. 14, the display apparatus 1 may receive second content data through the content receiver 63 or the communication module 90, in 1110. In this case, like what is described above, the second content data may include both data corresponding to an image for the left eye and data corresponding to an image for the right eye.

The display apparatus 1 may obtain a user input through the input device 61 or the remote signal receiver 62. For example, the display apparatus 1 may obtain a user input to select a type of content image through the input device 61 or the remote signal receiver 62. The processor 51 may receive the user input about the type of content image from the input device 61 or the remote signal receiver 62.

Based on the user input for displaying the first type of content image not being obtained (or based on the user input for displaying the second type of content image being obtained), the processor 51 may determine to perform the blocking mode in 1120 and determine to display the second type of content image in 1130. Based on the user input for displaying the first type of content image not being obtained, the processor 51 may control the parallax barrier 100 to perform the blocking mode, in 1120 Based on the user input for displaying the first type of content image not being obtained, the processor 51 may control the display panel 10 to display the second type of content image in 1130.

A procedure in which the processor 51 controls the parallax barrier 100 to perform the blocking mode and a procedure for controlling the display panel 10 to display the second type of content image are the same as what are described above in connection with FIG. 13, so the description thereof will not be repeated.

Based on the user input for displaying the first type of content image being obtained in 1111, the processor 51 may determine to perform the transmitting mode in 1020 and determine to display the second type of content image in 1230.

Based on the user input for displaying the first type of content image being obtained, the processor 51 may control the parallax barrier 100 to perform the transmitting mode, in 1020 The procedure in which the processor 51 controls the parallax barrier 100 to perform the transmitting mode is the same as what is described above with reference to FIG. 12, so the description thereof will not be repeated.

Based on the user input for displaying the first type of content image being obtained, the processor 51 may control the display panel 10 to display the first type of content image in 1230. For example, the processor 51 may generate the first type of content image by reconstructing one of data corresponding to the image for the left eye or data corresponding to the image for the right eye among data included in the second content data, and control the display panel 10 to display the first type of content image.

Although it is shown in FIG. 14 that the performing of the transmitting mode in 1020 is followed by the displaying of the first type of content image in 1230, a method of controlling the display apparatus according to an aspect of the disclosure is not limited thereto. The performing of the transmitting mode in 1020 and the displaying of the first type of content image in 1230 may be almost simultaneously performed.

The first content signal for displaying the first content image may be a signal output based on receiving the first content data through the content receiver 63 or the communication module 90 and simultaneously receiving a user input for displaying the first type of content image through the input device 61 or the remote signal receiver 62.

The second content signal for displaying the second content image may be a signal output based on receiving the second content data through the content receiver 63 or the communication module 90 and simultaneously, not receiving a user input for displaying the first type of content image (or receiving a user input for displaying the second type of content image) through the input device 61 or the remote signal receiver 62.

With these steps, the display apparatus 1 may provide a 2D image or 3D image for the user in response to a user input.

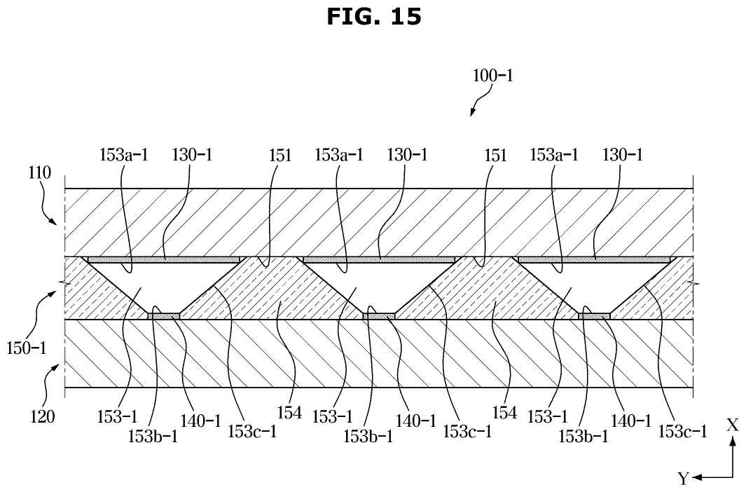

FIG. 15 is a cross-sectional view of a parallax barrier of a display apparatus, according to one or more embodiments of the disclosure.

In describing the display apparatus according to one or more embodiments with reference to FIG. 15, the same components as in the embodiments shown in FIGS. 1 to 14 may have the same reference numerals and the description thereof will not be repeated.

Referring to FIG. 15, in one or more embodiments of the disclosure, a parallax barrier 100-1 of the display apparatus 1 may include a switching layer 150-1 that includes switching cells 153-1 for selectively transmitting or blocking light.

The switching layer 150-1 may include the first surface 151 on which first electrodes 130 are arranged, and the second surface 152 on which second electrodes 140-1 are arranged.

For example, the first surface 151 may be arranged on one side of the switching layer 150-1 that faces the first substrate 110. The first electrode 130-1 may be arranged on the first substrate 110.

For example, the second surface 152 may be arranged on the other side of the switching layer 150-1 that faces the second substrate 120. The second electrode 140-1 may be arranged on the second substrate 120.

The first surface 151 may be located in front of the second surface 152. The first electrode 130-1 may be located in front of the second electrode 140-1.

The switching cell 153-1 may include a first end 153a-1 adjacent to the first electrode 130-1 and a second end 153b-1 adjacent to the second electrode 140-1. The first electrode 130-1 may be located at the first end 153a-1. The second electrode 140-1 may be located at the second end 153b-1. For example, the first end 153a-1 may be located at the front end of the switching cell 153-1. The second end 153b-1 may be located at the rear end of the switching cell 153-1.

The switching cell 153-1 may be formed in a shape that has decreasing width toward the second surface 152 from the first surface 151. In other words, the switching cell 153-1 may be formed in a shape that has decreasing width toward the second end 153b-1 from the first end 153a-1. Also, in other words, the switching cell 153-1 may be formed in a shape that has decreasing width toward the second electrode 140-1 from the first electrode 130-1.

For example, the switching cell 153-1 may be formed in a shape that has decreasing width toward the back of the display apparatus 1.

The switching cell 153-1 may include an inclined surface 153c-1 arranged between the first surface 151 and the second surface 152. The inclined surface 153c-1 may be arranged between the first end 153a-1 and the second end 153b-1. The inclined surface 153c-1 may be placed between the first electrode 130-1 and the second electrode 140-1.

The inclined surface 153c-1 may be formed to be inclined to a direction perpendicular to each of the first surface 151 and the second surface 152. The inclined surface 153c-1 may extend in a inclined direction to a direction (direction X with respect to the drawings) in which the first surface 151 and the second surface 152 face each other. The inclined surface 153c may be inclined in a different direction from the direction in which the first substrate 110 and the second substrate 120 face each other.

The inclined surface 153c-1 may be formed to be closer to the second electrode 140-1 in the extending direction of the second surface 152 (in the direction Y with respect to the drawings) when it goes to the second electrode 140-1 from the first electrode 130-1. The extending direction of the second surface 152 refers to a direction parallel to the Y-Z plane with respect to the drawings, i.e., at least one of directions perpendicular to the front-back direction of the display apparatus 1.

The switching cell 153-1 may be narrower in width on the second surface 152 than on the first surface 151. In other words, the width of the second end 153b-1 may be narrower than the width of the first end 153a-1.

For example, the first end 153a-1 of the switching cell 153-1 may be formed to have width corresponding to the width of the first electrode 130-1. Furthermore, for example, the second end 153b-1 of the switching cell 153-1 may be formed to have width corresponding to the width of the second electrode 140-1. The second electrode 140-1 may be formed to have width narrower than the first electrode 130-1.

When the parallax barrier 100-1 operates in the transmitting mode, an electric field may be applied between the first electrode 130-1 and the second electrode 140-1 to apply electric force for the charged particles CP to be directed to the second electrode 140-1. Specifically, based on an electric signal for performing the transmitting mode, the processor 51 may control the parallax barrier 100-1 to apply an electric field between the first electrode 130-1 and the second electrode 140-1 to apply electric force for the charged particles CP in the switching cell 153-1 to be directed to the second electrode 140-1. Accordingly, the charged particles CP in the switching cell 153-1 may be concentrated in a location adjacent to the second end 153b-1.

When the charged particles CP move in the switching cell 153 according to an electric field applied between the first electrode 130-1 and the second electrode 140-1, the inclined surface 153c-1 may perform a function of guiding the charged particles CP to be concentrated at the second end 153b-1.

When the parallax barrier 100-1 operates in the blocking mode, no electric field may be applied between the first electrode 130-1 and the second electrode 140-1, and thus, the charged particles CP in the switching cell 153-1 may be dispersed.

Although there are three switching cells 153-1 included in the switching layer 150 in FIG. 15, it is merely for convenience of illustration and the disclosure is not limited thereto.

FIG. 16 is a cross-sectional view of a parallax barrier of a display apparatus, according to one or more embodiments of the disclosure.

In describing the display apparatus according to one or more embodiments with reference to FIG. 16, the same components as in the embodiments shown in FIGS. 1 to 14 may have the same reference numerals and the description thereof will not be repeated.

Referring to FIG. 16, in one or more embodiments of the disclosure, a parallax barrier 100-2 of the display apparatus 1 may include a switching layer 150-2 that includes switching cells 153-2 for selectively transmitting or blocking light.

The switching layer 150-1 may include the first surface 151 on which first electrodes 130-2 are arranged, and the second surface 152 on which second electrodes 140-2 are arranged.

For example, the first surface 151 may be arranged on one side of the switching layer 150-2 that faces the first substrate 110. The first electrode 130-2 may be arranged on the first substrate 110.

For example, the second surface 152 may be arranged on the other side of the switching layer 150-2 that faces the second substrate 120. The second electrode 140-1 may be arranged on the second substrate 120.

The switching cell 153-1 may include a first end 153a-2 adjacent to the first electrode 130-2 and a second end 153b-2 adjacent to the second electrode 140-2. The first electrode 130-2 may be located at the first end 153a-2. The second electrode 140-2 may be located at the second end 153b-2.

The switching cell 153-2 may have a form that has decreasing width toward the first surface 151 from a certain location between the first surface 151 and the second surface 152, and that has decreasing width toward the second surface 152 from the certain location between the first surface 151 and the second surface 152. In other words, the switching cell 153-2 may have a form that has decreasing width toward the first end 153a-2 from a certain location between the first end 153a-2 and the second end 153b-2, and that has decreasing width toward the second end 153b-2 from the certain location between the first end 153a-2 and the second end 153b-2.

Also, in other words, the switching cell 153-2 may have a form that has decreasing width toward the first electrode 130-2 from a certain location between the first electrode 130-2 and the second electrode 140-2, and that has decreasing width toward the second electrode 140-2 from the certain location between the first electrode 130-2 and the second electrode 140-2.

Specifically, the switching cell 153-2 may have the widest width in the direction parallel to the first surface 151 and the second surface 152 at the certain location between the first surface 151 and the second surface 152.

The switching cell 153-2 may include a first inclined surface 153c-2 and a second inclined surface 153d-2 arranged between the first surface 151 and the second surface 152.

The first inclined surface 153c-2 and the second inclined surface 153d-2 may each be formed to be inclined to a direction perpendicular to each of the first surface 151 and the second surface 152. The first inclined surface 153c-2 and the second inclined surface 153d-2 may each extend in a inclined direction to a direction (direction X with respect to the drawings) in which the first surface 151 and the second surface 152 face each other. The first inclined surface 153c-2 and a second inclined surface 153d-2 may each be inclined in a direction different from the direction in which the first substrate 110 and the second substrate 120 face each other.

The first inclined surface 153c-2 may be arranged between the certain location between the first surface 151 and the second surface 152 and the first surface 151. The first inclined surface 153c-2 may be arranged between the certain location between the first end 153a-2 and the second end 153b-2 and the first end 153a-2. The first inclined surface 153c-2 may be arranged between the certain location between the first electrode 130-2 and the second electrode 140-2 and the first electrode 130-2.

The first inclined surface 153c-2 may be formed to be closer to the first electrode 130-2 in the extending direction of the first surface 151 as it goes toward the first electrode 130-2. The extending direction of the first surface 151 refers to a direction parallel to the Y-Z plane with respect to the drawings, i.e., at least one of directions perpendicular to the front-back direction of the display apparatus 1.

The second inclined surface 153d-2 may be arranged between the certain location between the first surface 151 and the second surface 152 and the second surface 152. The second inclined surface 153d-2 may be arranged between the certain location between the first end 153a-2 and the second end 153b-2 and the second end 153b-1. The second inclined surface 153d-2 may be arranged between the certain location between the first electrode 130-2 and the second electrode 140-2 and the second electrode 140-1.

The second inclined surface 153d-2 may be formed to be closer to the second electrode 140-2 in the extending direction of the second surface 152 as it goes toward the second electrode 140-2. The extending direction of the second surface 152 refers to a direction parallel to the Y-Z plane with respect to the drawings, i.e., at least one of directions perpendicular to the front-back direction of the display apparatus 1.

The first inclined surface 153c-2 and the second inclined surface 153d-2 may be connected to each other.

The switching cell 153-2 may be narrower in width on the first surface 151 than on the second surface 152. In other words, the width of the first end 153a-2 may be narrower than the width of the second end 153b-2.

For example, the first end 153a-2 of the switching cell 153-2 may be formed to have width corresponding to the width of the first electrode 130-2. Furthermore, for example, the second end 153b-2 of the switching cell 153-2 may be formed to have width corresponding to the width of the second electrode 140-2. The first electrode 130-2 may be formed to have width narrower than the second electrode 140-2.

It is not, however, limited thereto, and the switching cell 153-2 may be formed so that the width of the first end 153a-2 and the width of the second end 153b-2 are almost the same or similar to each other.

When the parallax barrier 100-2 operates in the transmitting mode, an electric field may be applied between the first electrode 130-2 and the second electrode 140-2 to apply electric force for the charged particles CP to be directed to the first electrode 130-2. Specifically, based on an electric signal for performing the transmitting mode, the processor 51 may control the parallax barrier 100-2 to apply an electric field between the first electrode 130-2 and the second electrode 140-2 to apply electric force for the charged particles CP in the switching cell 153-2 to be directed to the first electrode 130-2. Accordingly, the charged particles CP in the switching cell 153-2 may be concentrated in a location adjacent to the first end 153a-2.

When the parallax barrier 100-2 operates in the blocking mode, no electric field may be applied between the first electrode 130-2 and the second electrode 140-2, and thus, the charged particles CP in the switching cell 153-2 may be dispersed.

Although there are two switching cells 153-2 included in the switching layer 150-2 in FIG. 16, it is merely for convenience of illustration and the disclosure is not limited thereto.

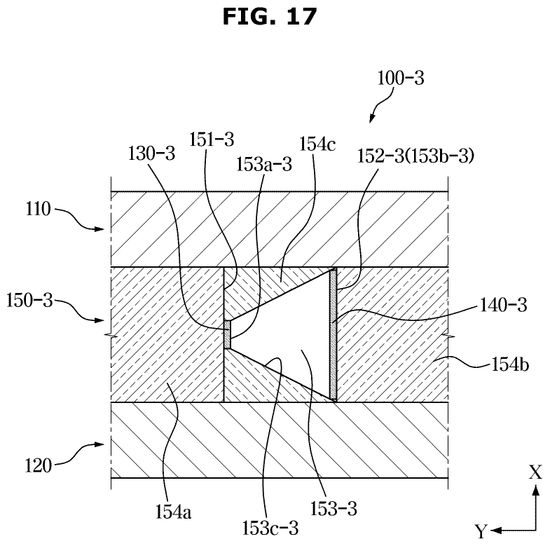

FIG. 17 is a cross-sectional view of a parallax barrier of a display apparatus, according to one or more embodiments of the disclosure.

In describing the display apparatus according to one or more embodiments with reference to FIG. 17, the same components as in the embodiments shown in FIGS. 1 to 14 may have the same reference numerals and the description thereof will not be repeated.

Referring to FIG. 17, in one or more embodiments of the disclosure, a parallax barrier 100-3 of the display apparatus 1 may include a switching layer 150-3 that includes a switching cell 153-3 for selectively transmitting or blocking light.

The switching layer 150-3 may include a first transmission portion 154a, a second transmission portion 154b and a third transmission portion 154c, which are arranged to transmit light. The third transmission portion 154c may be located between the first transmission portion 154a and the second transmission portion 154b. The first transmission portion 154a, the third transmission portion 154c and the second transmission portion 154b may be sequentially arranged in an extending direction of the switching layer 150-3. The extending direction of the switching layer 150-3 refers to a direction parallel to the Y-Z plane with respect to the drawings, i.e., at least one of directions perpendicular to the front-back direction of the display apparatus 1.

The extending direction of the switching layer 150-3 may be parallel to each of extending directions of the first substrate 110, the second substrate 120 and the display panel 10.

The first transmission portion 154a, the second transmission portion 154b and the third transmission portion 154c may each have corresponding characteristics to the transmission portion 154 as described above with reference to FIGS. 1 to 15, so the detailed description will not be repeated.

The switching layer 150-3 may include a first surface 151-3 on which a first electrode 130-3 is arranged, and a second surface 152-3 on which a second electrode 140-3 is arranged.

The first electrode 130-3 may be electrically connected to the first substrate 110. The second electrode 140-3 may be electrically connected to the second substrate 120.

However, unlike what are shown in FIGS. 7 to 16, the first electrode 130-3 may be located between the first substrate 110 and the second substrate 120, i.e., inside the switching layer 150-3. Furthermore, the second electrode 140-3 may be located between the first substrate 110 and the second substrate 120, i.e., inside the switching layer 150-3.

The first electrode 130-3 may be electrically positioned to the first substrate 110 in various methods inside the switching layer 150-3. The first electrode 140-3 may be electrically positioned to the second substrate 120 in various methods inside the switching layer 150-3.

The first surface 151-3 may be arranged on one side of the first transmission portion 154a. The first surface 151-3 may be located on a border between the first transmission portion 154a and the third transmission portion 154c. The first electrode 130-3 may be located on a border between the switching cell 153-3 and the first transmission portion 154a.

The second surface 152-3 may be arranged on one side of the second transmission portion 154b. The second surface 152-3 may be located on a border between the second transmission portion 154b and the third transmission portion 154c. The second electrode 140-3 may be located on a border between the switching cell 153-3 and the second transmission portion 154b.

The first surface 151-3 and the second surface 152-3 may be arranged to face each other in the extending direction (the Y direction with respect to the drawings) of the switching layer 150-3. The first electrode 130-3 and the second electrode 140-3 may be arranged to face each other in the extending direction of the switching layer 150-3.

The extending direction of the switching layer 150-3 may be parallel to each of extending directions of the first substrate 110, the second substrate 120 and the display panel 10.

In other words, the direction in which the first surface 151-3 and the second surface 152-3 face each other may be almost perpendicular to the direction in which the first surface 151 and the second surface 152 face each other in FIGS. 7 to 16. Furthermore, the direction in which the first electrode 130-3 and the second electrode 140-3 face each other may be almost perpendicular to the direction in which the first electrode 130, 130-1 or 130-2 and the second electrode 140, 140-1 or 140-2 face each other in FIGS. 7 to 16.

The switching cell 153-1 may include a first end 153a-3 adjacent to the first electrode 130-3 and a second end 153b-3 adjacent to the second electrode 140-3. The first electrode 130-3 may be located at the first end 153a-3. The second electrode 140-1 may be located at the second end 153b-3.

The switching cell 153-3 may be formed in a shape that has decreasing width toward the first surface 151-3 from the second surface 152-3. In other words, the switching cell 15331 may be formed in a shape that has decreasing width toward the first end 153a-3 from the second end 153b-3. Also, in other words, the switching cell 153-3 may be formed in a shape that has decreasing width toward the first electrode 130-3 from the second electrode 140-3.

That is, the switching cell 153-3 may be formed to have decreasing width toward one direction (direction Y with respect to the drawings) among the horizontal directions of the display panel 10.

The switching cell 153-3 may include an inclined surface 153c-3 arranged between the first surface 151-3 and the second surface 152-3. The inclined surface 153c-3 may be arranged between the first end 153a-3 and the second end 153b-3. The inclined surface 153c-3 may be placed between the first electrode 130-3 and the second electrode 140-3.

The inclined surface 153c-3 may be formed to be inclined to a direction perpendicular to each of the first surface 151-3 and the second surface 152-3. The inclined surface 153c-3 may extend in a inclined direction to a direction (direction Y with respect to the drawings) in which the first surface 151-3 and the second surface 152-3 face each other.

The inclined surface 153c-3 may be formed to be closer to the first electrode 130-3 in the extending direction of the first surface 151-3 (in the direction X with respect to the drawings, i.e., in the front-back direction of the display apparatus 1) when it goes to the first electrode 130-1 from the second electrode 140-3.

The switching cell 153-3 may be narrower in width on the first surface 151-3 than on the second surface 152-3. In other words, the width of the first end 153a-3 may be narrower than the width of the second end 153b-3.

For example, the first end 153a-3 of the switching cell 153-3 may be formed to have width corresponding to the width of the first electrode 130-3. Furthermore, for example, the second end 153b-3 of the switching cell 153-3 may be formed to have width corresponding to the width of the second electrode 140-3. The first electrode 130-3 may be formed to have width narrower than the second electrode 140-3.

When the parallax barrier 100-3 operates in the transmitting mode, an electric field may be applied between the first electrode 130-3 and the second electrode 140-3 to apply electric force for the charged particles CP to be directed to the first electrode 140-3. Specifically, based on an electric signal for performing the transmitting mode, the processor 51 may control the parallax barrier 100-3 to apply an electric field between the first electrode 130-3 and the second electrode 140-3 to apply electric force for the charged particles CP in the switching cell 153-3 to be directed to the first electrode 130-3. Accordingly, the charged particles CP in the switching cell 153-3 may be concentrated in a location adjacent to the first end 153a-3.

When the charged particles CP move in the switching cell 153-3 according to an electric field applied between the first electrode 130-3 and the second electrode 140-3, the inclined surface 153c-3 may perform a function of guiding the charged particles CP to be concentrated at the first end 153a-3.

When the parallax barrier 100-3 operates in the blocking mode, no electric field may be applied between the first electrode 130-3 and the second electrode 140-3, and thus, the charged particles CP in the switching cell 153-3 may be dispersed.

Although there are only one switching cell 153-3 included in the switching layer 150-3 in FIG. 17, it is merely for convenience of illustration and the disclosure is not limited thereto.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In one or more embodiments of the present disclosure, the aforementioned method according to the various embodiments of the present disclosure may be provided in a computer program product. The computer program product may be a commercial product that may be traded between a seller and a buyer. The computer program product may be distributed in the form of a recording medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a recording medium that may be readable to a device such as a server of the manufacturer, a server of the application store, or a relay server.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A display apparatus comprising:
a light source module configured to irradiate light;
a first substrate disposed in front of the light source module in a forward direction and configured to transmit the light irradiated by the light source module;
a second substrate facing the first substrate, disposed between the first substrate and the light source module, and configured to transmit the light irradiated by the light source module; and
a switching layer between the first substrate and the second substrate and comprising:
a first surface having a first electrode arranged thereon;
a second surface having a second electrode arranged thereon and facing the first surface; and
a switching cell, arranged between the first surface and the second surface and comprising movable charged particles having of a light-blocking material, configured to transmit or block the light based on an electric potential difference applied to the first electrode and the second electrode,
wherein the switching cell has a shape with a decreasing width in an extending direction of the first surface from the second surface toward the first surface.

2. The display apparatus of claim 1, wherein the switching cell comprises an inclined surface between the first electrode and the second electrode with respect to a direction perpendicular to each of the first surface and the second surface, and
wherein the inclined surface is on an inner surface of the switching cell.

3. The display apparatus of claim 2, wherein a distance between a first end of the inclined surface adjacent to the first surface and the first electrode in the extending direction of the first surface is less than a distance between a second end of the inclined surface adjacent to the second surface and the first electrode in the extending direction of the first surface.

4. The display apparatus of claim 2, wherein the inclined surface comprises a plurality of inclined surfaces facing each other, and
wherein the plurality of inclined surfaces extend to be closer to each other toward the first electrode.

5. The display apparatus of claim 2, wherein the inclined surface extends from the second surface to the first surface.

6. The display apparatus of claim 2, wherein the switching cell extends in a direction parallel to the extending direction of the first surface and the second surface, and
wherein the inclined surface extends in the direction parallel to the extending direction of the first surface and the second surface.

7. The display apparatus of claim 1, wherein a first end of the switching cell on the first surface has a width corresponding to a width of the first electrode, and
wherein a second end of the switching cell on the second surface has a width corresponding to a width of the second electrode.

8. The display apparatus of claim 7, wherein the width of the first end of the switching cell is less than the width of the second end of the switching cell.

9. The display apparatus of claim 1, wherein the first surface is on one side of the switching layer facing the first substrate,
wherein the first electrode is connected to the first substrate,
wherein the second surface is on another side of the switching layer facing the second substrate, and
wherein the second electrode is connected to the second substrate.

10. The display apparatus of claim 1, further comprising one or more processors,
wherein a power supply is connected to the first electrode and the second electrode and configured to apply an electric field between the first electrode and the second electrode, and
wherein the one or more processors are configured to control the power supply to apply the electric field between the first electrode and the second electrode for applying electric force to charged particles in the switching cell to be directed to the first electrode, based on an electric signal for the switching cell to perform a transmitting mode for transmitting the light.

11. The display apparatus of claim 10, wherein the one or more processors are further configured to control the power supply not to apply the electric field between the first electrode and the second electrode, based on an electric signal for the switching cell to perform a blocking mode for blocking the light.

12. The display apparatus of claim 11, wherein the one or more processors are further configured to:
control the power supply to perform the transmitting mode based on a first content signal for displaying a first type of content image, the first content signal being based on a first user input; and
control the power supply to perform the blocking mode based on a second content signal for displaying a second type of content image, the second content signal being based on a second user input different than the first user input, and the second type of content image being different from the first type of content image.

13. The display apparatus of claim 1, wherein the switching cell comprises a plurality of switching cells spaced apart from each other,
wherein the switching layer further comprises a transmission portion between the plurality of switching cells and configured to transmit the light, and
wherein a boundary between the transmission portion and each of the plurality of switching cells extends obliquely in a direction perpendicular to each of the first surface and the second surface.

14. The display apparatus of claim 13, wherein each of the plurality of switching cells comprises a dispersion medium in each of the plurality of switching cells and configured to transmit the light, and
wherein the transmission portion is a material having a refraction index corresponding to a refraction index of the dispersion medium.

15. The display apparatus of claim 13, wherein the plurality of switching cells are arranged at equal intervals.
